(19) United States
(12) Patent Application Publication
(10) Pub. No.: US 2026/0089727 A1
(43) Pub. Date: Mar. 26, 2026

(54) CROSS-BEAM RMSI PDXCH COMBINING

(71) Applicant: QUALCOMM Incorporated, San Diego, CA (US)

(72) Inventors: In-Soo KIM, San Diego, CA (US); Yan ZHOU, San Diego, CA (US); Tao LUO, San Diego, CA (US); Jing JIANG, San Diego, CA (US)

(21) Appl. No.: 18/894,955

(22) Filed: Sep. 24, 2024

(51) Int. Cl. H04W 72/23; H04B 17/318

(52) U.S. Cl. CPC H04W 72/23; H04B 17/328

(57) ABSTRACT

Cross-beam RMSI PDxCH combining is described. An apparatus is configured to receive, from a network node, a set of configuration indications associated with a cross-beam combination for PDCCHs. The apparatus is configured to receive, from the network node and in accordance with the set of configuration indications, the PDCCHs. Another apparatus is configured to provide, for a UE, a set of configuration indications associated with a cross-beam combination for PDCCHs. The apparatus is configured to provide, for the UE and in accordance with the set of configuration indications, the PDCCHs.

### TECHNICAL FIELD

The present disclosure relates generally to communication systems, and more particularly, to a wireless system utilizing remaining minimum system information (RMSI).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be, or may comprise, a user equipment (UE). The apparatus is configured to receive, from a network node, a set of configuration indications associated with a cross-beam combination for physical downlink control channels (PDCCHs). The apparatus is configured to receive, from the network node and in accordance with the set of configuration indications, the PDCCHs.

In the aspect, the method includes receiving, from a network node, a set of configuration indications associated with a cross-beam combination for PDCCHs. The method includes receiving, from the network node and in accordance with the set of configuration indications, the PDCCHs.

In another aspect of the disclosure, a method, a computer-readable medium, and an apparatus are provided. The apparatus is configured to provide, for a UE, a set of configuration indications associated with a cross-beam combination for PDCCHs. The apparatus is configured to provide, for the UE and in accordance with the set of configuration indications, the PDCCHs.

In the aspect, the method includes providing, for a UE, a set of configuration indications associated with a cross-beam combination for PDCCHs. The method includes providing, for the UE and in accordance with the set of configuration indications, the PDCCHs.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of RMSI transport block sizes (TBSs)/payloads and synchronization signal block (SSB) multiplexing patterns.

FIG. 5 is a diagram illustrating examples of SSB multiplexing patterns and cross-SSB burst combinations.

FIG. 6 is a call flow diagram for wireless communications, in accordance with various aspects of the present disclosure.

FIG. 7 is a diagram illustrating examples of cross-beam RMSI PDxCH combinations, in accordance with various aspects of the present disclosure.

FIG. 8 is a diagram illustrating examples of cross-beam RMSI PDxCH combinations for SSB bursts, in accordance with various aspects of the present disclosure.

FIG. 9 is a diagram illustrating examples of cross-beam RMSI PDxCH combinations with RV cycling pattern configurations, in accordance with various aspects of the present disclosure.

FIG. 10 is a diagram illustrating examples of RV cycling pattern configurations with rotation, in accordance with various aspects of the present disclosure.

FIG. 11 is a diagram illustrating examples of cross-beam PDxCH combinations for multicasting/broadcasting, in accordance with various aspects of the present disclosure.

FIG. 12 is a flowchart of a method of wireless communication.

FIG. 13 is a flowchart of a method of wireless communication.

FIG. 14 is a diagram illustrating an example of a hardware implementation for an example apparatus and/or network entity.

FIG. 15 is a diagram illustrating an example of a hardware implementation for an example network entity.

### DETAILED DESCRIPTION

Wireless communication networks may be designed to support communications between network nodes (e.g., base stations, gNBs, etc.)/network entities (e.g., in a core network, network nodes, etc.) and UEs. A UE may receive various types of system information (SI) in a wireless communication network, e.g., 5G NR or others, through different channels and mechanisms. As examples, a master information block (MIB) via a physical broadcast channel (PBCH) may be periodically broadcast, a type 1 system information block (SIB) (SIB1)/RMSI may be provided via a physical downlink shared channel (PDSCH) that is scheduled by a PDCCH associated with a type 0 common search space (CSS) (Type0-CSS) as a periodic broadcast, and types 2, 3, 4, etc., SIBs, also other system information (OSI) may be provided via PDSCH scheduled by a PDCCH associated with a Type0A-CSS as on-demand deliver for UE requests.

However, in practice, the RMSI PDCCH that schedules the RMSI PDSCH is typically the coverage bottleneck, e.g., in frequency range designation FR2, due to the coarse beam direction stemming from the broadcast nature of the signaling. In addition, the RMSI PDSCH may also become the coverage bottleneck when the RMSI payload is large. Further, issues also exist in repeating the RMSI PDxCH to enhance the coverage as broadcast PDxCH repetition is not favorable due to the overhead involved (e.g., broadcast signaling and repetition lead to larger overhead), and moreover, there are cases where the RMSI PDXCH repetition is not possible, e.g., in SSB multiplexing patterns 2 and 3 that FDMs the RMSI PDxCH with the SSB in FR2. That is, there may be no room for the RMSI PDxCH repetition for the SSB multiplexing patterns 2 and 3. Some current solutions combine RMSI PDxCHs across SSB bursts (e.g., across time) to increase coverage, yet such approaches incur a latency of at least 20 ms for each RMSI PDxCH combination.

Various aspects relate generally to RMSI utilization. Some aspects more specifically relate to cross-beam RMSI PDxCH combining. In some examples, an apparatus, such as a UE, may receive, from a network node, a set of configuration indications associated with a cross-beam combination for PDCCHs and receive, from the network node and in accordance with the set of configuration indications, the PDCCHs. Another apparatus, such as a network node, may provide, for a UE, a set of configuration indications associated with a cross-beam combination for PDCCHs and provide, for the UE and in accordance with the set of configuration indications, the PDCCHs. Thus, aspects provide inter alia for PDxCH cross-beam combinations, e.g., across beams/frequencies.

Particular aspects of the subject matter described in this disclosure can be implemented to realize one or more of the following potential advantages. In some examples, by indicating to a UE that contents of RMSI PDCCHs are identical across SSB within an SSB burst, the described techniques can be used to increase coverage and decrease bottlenecks for RMSI PDxCHs. In some examples, by utilizing RV cycling configurations applicable to spatial- and time-domains and that differ from PDCCH RVs, the described techniques can be used to provide for cross-beam combinations even when PDCCH contents are identical. In some examples, by providing indications of combinable candidate patterns for beams to a UE, the described techniques can be used to enable UEs to combine broadcast/multicast PDCCHs across beams within a monitoring occasion.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (cNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

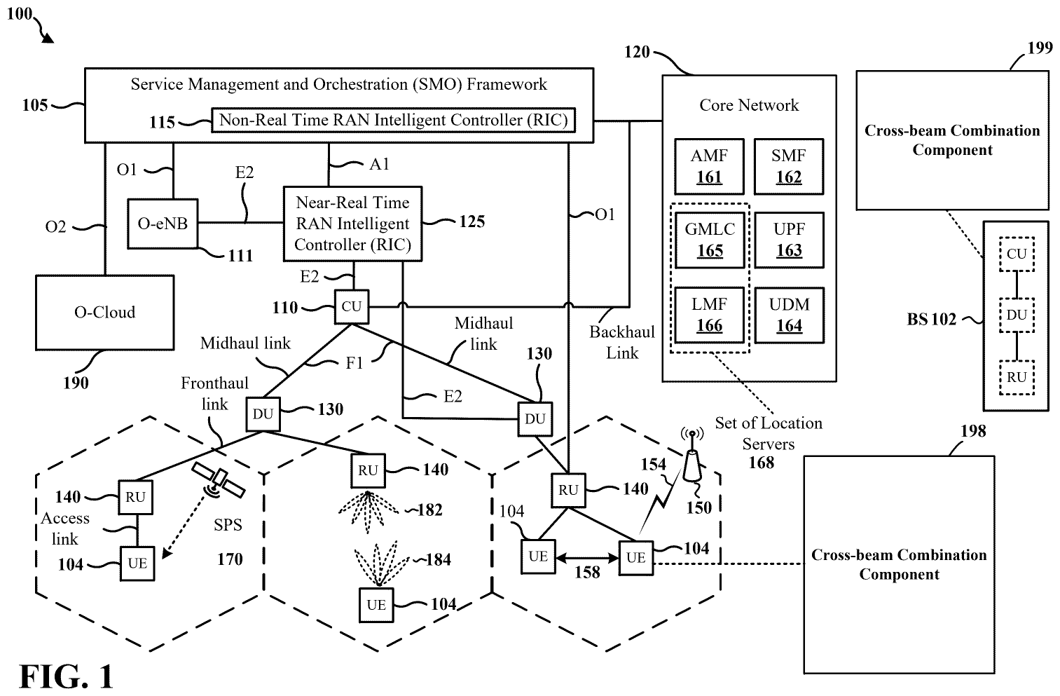

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-cNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ).

Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a cross-beam combination component 198 (“component 198”) that may be configured to receive, from a network node, a set of configuration indications associated with a cross-beam combination for PDCCHs. The component 198 may be configured to receive, from the network node and in accordance with the set of configuration indications, the PDCCHs. In certain aspects, the base station 102 may have a cross-beam combination component 199 (“component 199”) that may be configured to provide, for a UE, a set of configuration indications associated with a cross-beam combination for PDCCHs. The component 199 may be configured to provide, for the UE and in accordance with the set of configuration indications, the PDCCHs. Accordingly, aspects provide for improved coverage and reduced bottlenecks for RMSI PDxCHs by indicating to a UE that contents of RMSI PDCCHs are identical across SSB within an SSB burst, provide for cross-beam combinations even when PDCCH contents are identical by utilizing RV cycling configurations applicable to spatial- and time-domains and that differ from PDCCH RVs, and enable UEs to combine broadcast/multicast PDCCHs across beams within a monitoring occasion by providing indications of combinable candidate patterns for beams to a UE.

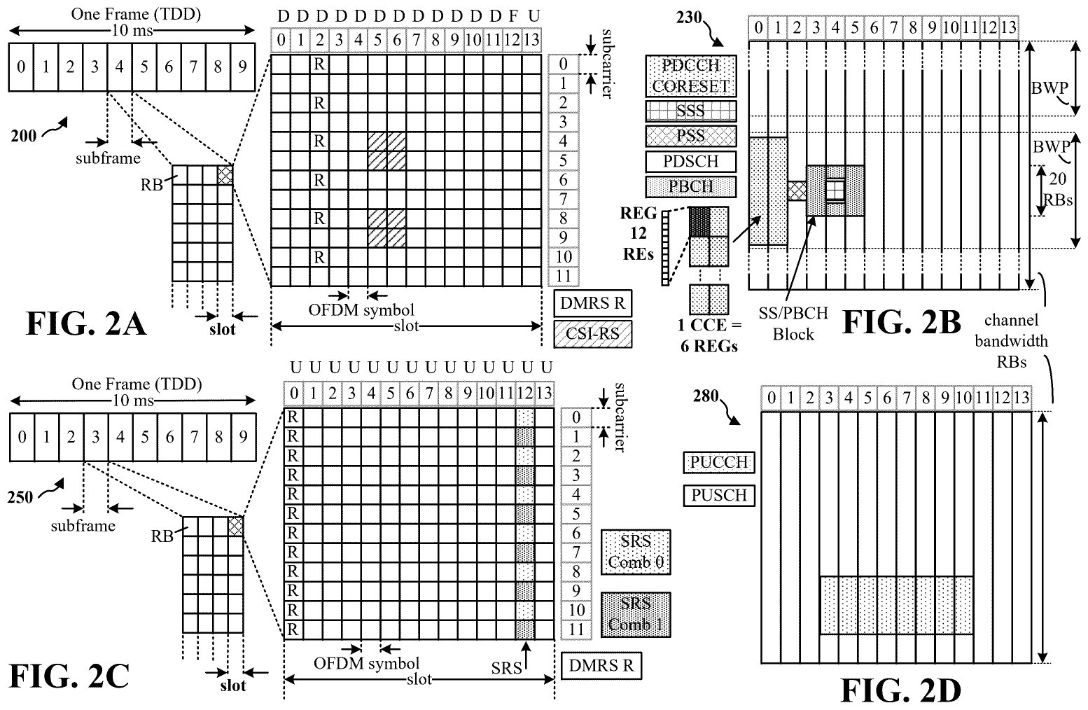

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

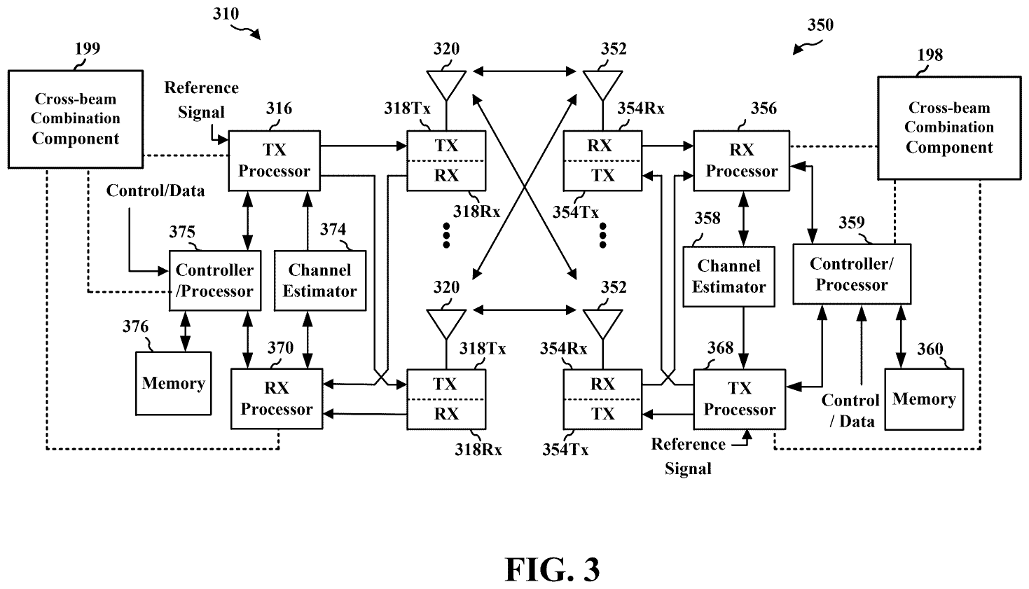

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the component 198 of FIG. 1.

At least one of the TX processor 316, the RX processor 370, and the controller/processor 375 may be configured to perform aspects in connection with the component 199 of FIG. 1.

A UE may receive various types of system information (SI) in a wireless communication network, e.g., 5G NR or others, through different channels and mechanisms. As examples, a master information block (MIB) via a physical broadcast channel (PBCH) may be periodically broadcast, a type 1 system information block (SIB1), also remaining minimum system information (RMSI) may be provided via a physical downlink shared channel (PDSCH) that is scheduled by a physical downlink control channel (PDCCH) associated with a Type0-CSS as a period broadcast, and types 2, 3, 4, etc., SIBs, also other system information (OSI) may be provided via PDSCH scheduled by a PDCCH associated with a Type0A-CSS as on-demand deliver for UE requests. However, in current practice, the RMSI PDCCH that schedules the RMSI PDSCH is typically the coverage bottleneck, e.g., in frequency range designation FR2, due to the coarse beam direction stemming from the broadcast nature of the signaling. In addition, the RMSI PDSCH may also become the coverage bottleneck when the RMSI payload is large. Further, issues also exist in repeating the RMSI PDxCH to enhance the coverage as broadcast PDxCH repetition is not favorable due to the overhead involved (e.g., broadcast signaling and repetition lead to larger overhead), and moreover, there are cases where the RMSI PDxCH repetition is not possible, e.g., in synchronization signal block (SSB) multiplexing patterns 2 and 3 that frequency division multiplexes (FDMs) the RMSI PDCCH/PDSCH (also “PDxCH”) with the SSB in FR2. That is, there may be no room for the RMSI PDxCH repetition for the SSB multiplexing patterns 2 and 3. Some current solutions combine RMSI PDxCHs across SSB bursts (e.g., across time) to increase coverage, yet such approaches incur a latency of at least 20 ms for each RMSI PDxCH combination.

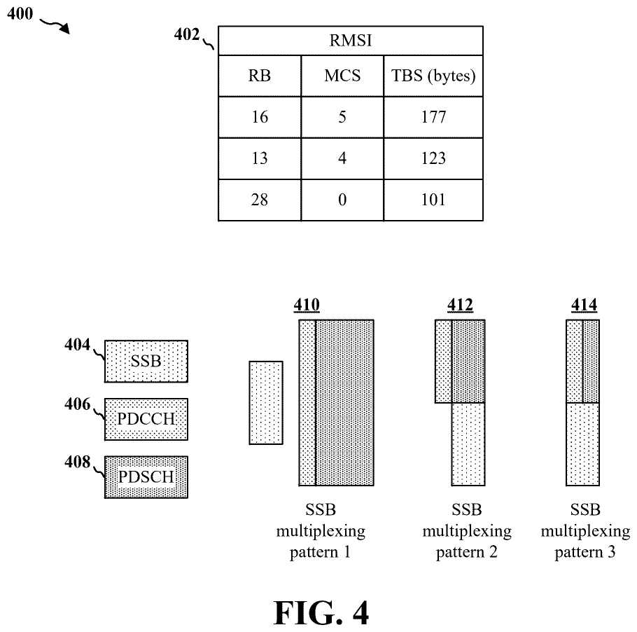

FIG. 4 is a diagram 400 illustrating an example of RMSI TBSs/payloads and SSB multiplexing patterns. Diagram 400 is shown in the context of RMSI payloads 402 and a SSB 404, a PDCCH 406, and a PDSCH 408.

The RMSI payloads 402 show example implementations for numbers of resource blocks (RBs) for a given modulation and coding scheme (MCS). For instance, an implementation with 16 RBs and MCS 5 may have an RMSI payload/TBS of 177 bytes. An implementation with 13 RBs and MCS 54 may have an RMSI payload/TBS of 123 bytes. As another example, an implementation with 28 RBs and MCS 0 may have an RMSI payload/TBS of 101 bytes. Accordingly, it may be seen that RMSI payloads 402 may be large and cause bottlenecks/decreased coverage.

As noted herein, a PDSCH that is scheduled by a PDCCH associated with a Type0-CSS as a periodic broadcast, and the RMSI may periodically broadcast based on the predefined SSB multiplexing pattern every 160 ms RMSI transmission time interval (TTI). The SSB 404, the PDCCH 406, and the PDSCH 408 are shown for three implementations of SSB multiplexing patterns: an SSB multiplexing pattern 1 410, an SSB multiplexing pattern 2 412, and an SSB multiplexing pattern 3 414. The SSB multiplexing pattern 1 410 includes the SSB 404 preceding the PDCCH 406 and the PDSCH 408 with multiplexing in time. That is, the SSB multiplexing pattern 1 410 may time dimension multiplex (TDM) the RMSI PDxCH (e.g., the PDCCH 406 and the PDSCH 408) with the SSB 404 in FR1/FR2. The SSB multiplexing pattern 2 412 includes the PDCCH 406 preceding the SSB 404 and the PDSCH 408 with multiplexing in time between the PDCCH 406 and the SSB 404 that spatially multiplexed with the PDSCH 408. That is, the SSB multiplexing pattern 2 412 may FDM the RMSI PDxCH (e.g., the PDCCH 406 and the PDSCH 408) with the SSB 404 in FR2 ((SSB SCS, RMSI PDxCH SCS)=(120, 60) kHz or (240, 120) kHz for 1-symbol RMSI PDCCH+2-symbol RMSI PDSCH). The SSB multiplexing pattern 3 414 includes the PDCCH 406 preceding and time-multiplexed with the PDSCH 408, which are spatially multiplexed with the SSB 404. That is, the SSB multiplexing pattern 3 414 may FDM the RMSI PDxCH (e.g., the PDCCH 406 and the PDSCH 408) with the SSB 404 in FR2 ((SSB SCS, RMSI PDXCH SCS)=(120, 120) kHz for 2-symbol RMSI PDCCH+2-symbol RMSI PDSCH).

Yet, as noted above, there may be no room for the RMSI PDxCH repetition for the SSB multiplexing pattern 2 412 and the SSB multiplexing pattern 3 414 to increase PDxCH coverage. For instance, the SSB multiplexing pattern 2 412 and the SSB multiplexing pattern 3 414 confine the RMSI PDxCH (e.g., the PDCCH 406 and the PDSCH 408) within the SSB 404, which results in no room for RMSI PDxCH repetition in FR2.

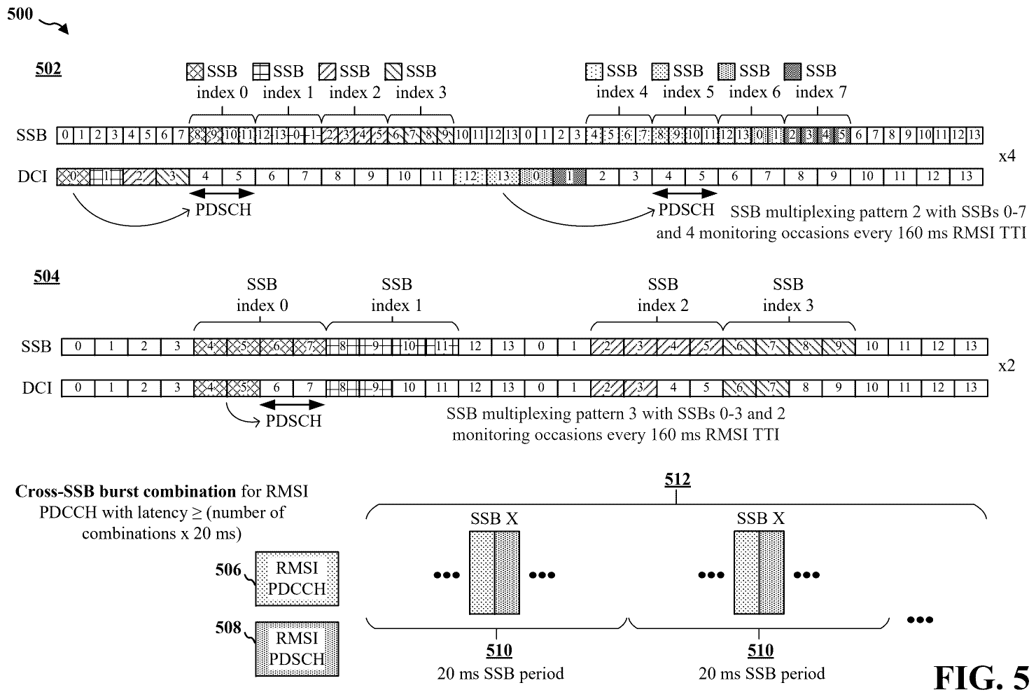

FIG. 5 is a diagram 500 illustrating examples of SSB multiplexing patterns and cross-SSB burst combinations. Diagram 500 is shown in the context of an SSB multiplexing pattern 2 502 and an SSB multiplexing pattern 3 504, as well as a cross-SSB burst combination 512 over time for a RMSI PDCCH 506 and an RMSI PDSCH 508, and is further illustrative of the lack of room for RMSI PDxCH repetition in FR2 described above with respect to FIG. 4.

The SSB multiplexing pattern 2 502 may include an SSB 0 to an SSB 7, and may have four monitoring occasions every 160 ms RMSI TTI. The SSB multiplexing pattern 3 504 may include an SSB 0 to an SSB 3, and may have two monitoring occasions every 160 ms RMSI TTI. Each SSB shown may have a corresponding SSB index and a corresponding DCI for PDSCHs, and such signaling does not allow for additional repetition thereof.

Additionally, combining RMSI PDxCHs (e.g., the RMSI PDCCH 506) across SSB bursts of the cross-SSB burst combination 512 (e.g., across time) to increase coverage incurs a latency of at least 20 ms for each RMSI PDxCH combination. That is, each SSB burst of the cross-SSB burst combination 512 may have an SSB period 510 of 20 ms,

Aspects provide techniques for enabling cross beam (e.g., SSB) RMSI PDCCH and PDSCH (e.g., PDxCH) combining. Aspects provide for introducing a bit in the MIB to indicate when combining two instances of PDCCH may be performed (e.g., PDCCH contents are the same). Aspects provide for RV cycling aspects of PDSCH transmission being hardcoded/configured (e.g., via a technical specification/standard) rather than being given through PDCCH. Aspects provide for RSRP thresholds that trigger a UE to attempt PDCCH/PDSCH (PDxCH) combining.

Aspects herein also for cross-beam RMSI PDxCH combining improve coverage and reduce bottlenecks for RMSI PDxCHs. Aspects increase coverage and decrease bottlenecks for RMSI PDxCHs by indicating to a UE that contents of RMSI PDCCHs are identical across SSB within an SSB burst. Aspects also provide for cross-beam combinations even when PDCCH contents are identical by utilizing RV cycling configurations applicable to spatial- and time-domains and that differ from PDCCH RVs. Aspects also enable UEs to combine broadcast/multicast PDCCHs across beams within a monitoring occasion by providing indications of combinable candidate patterns for beams to a UE.

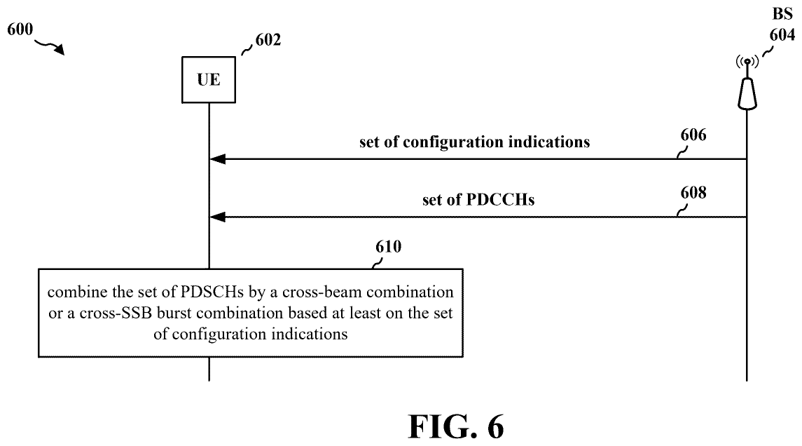

FIG. 6 is a call flow diagram 600 for wireless communications, in various aspects. Call flow diagram 600 illustrates cross-beam RMSI PDxCH combining for a UE (e.g., a UE 602), by way of example, that communicates with a network node (e.g., a base station 604, a gNB, etc., as shown and described herein), by way of example. While call flow diagram 600 is illustrated and described with respect to a base station, aspects include that the base station 604 may be two or more base stations. Aspects described for base stations, and for network nodes/entities herein, generally, may be performed in aggregated form and/or by one or more components in disaggregated form. Additionally, or alternatively, the aspects may be performed by a UE autonomously, in addition to, and/or in lieu of, operations of a network node/base station. As used herein, PDCCHs may be referred to as a set of PDCCHs, and vice versa, unless otherwise specified.

The UE 602 may be configured to receive, and the base station 604 may be configured to transmit/provide/configure the UE 602 with, a set of configuration indications 606. In aspects, the UE 602 may be configured to receive, from a network node (e.g., the base station 604), the set of configuration indications 606 associated with a cross-beam combination for PDCCHs (e.g., a set of PDCCHs 608).

The UE 602 may be configured to receive, and the base station 604 may be configured to transmit/provide, the set of PDCCHs 608. In aspects, the UE 602 may be configured to receive, from the network node (e.g., the base station 604) and in accordance with the set of configuration indications 606, the PDCCHs (e.g., the set of PDCCHs 608). In aspects, the set of PDCCHs 608 may comprise RMSI, and the RMSI may be associated with the cross-beam combination for RMSI PDCCHs (e.g., as the set of PDCCHs 608). In some aspects, the set of configuration indications 606 may comprise at least one of RMSI or OSI. In such aspects, the set of configuration indications 606 may be indicative of at least one of a PDCCH candidate identifier, a search space identifier associated with a search space, a radio network temporary identifier (RNTI), or a set of monitoring occasions associated with combinable PDCCH candidates for the cross-beam combination. In some aspects, the set of configuration indications 606 may comprise at least one of RMSI or OSI or RRC signaling, and the set of configuration indications 606 may be indicative of the set of monitoring occasions and a presence of each multicast PDCCH and associated beam at ones of the set of monitoring occasions.

In aspects, a configuration indication of the set of configuration indications 606 may be indicative of whether contents of the RMSI PDCCHs are identical across SSBs within an SSB burst. In aspects, such a configuration indication may be configured for a first value associated with the contents of the RMSI PDCCHs being identical across the SSBs within the SSB burst or a second value associated with the contents of the RMSI PDCCHs being non-identical across the SSBs within the SSB burst. In aspects, the configuration indication may include a 1-bit field indicator comprised in a MIB.

In aspects, a configuration indication of the set of configuration indications 606 may be indicative of contents of the RMSI PDCCHs being identical across SSBs for at least one SSB burst of a set of SSB bursts. In such aspects, the configuration indication may be configured for a first value associated with each even numbered SSB as the at least one SSB burst, a second value associated with each odd numbered SSB as the at least one SSB burst, a third value associated with a first SSB burst as the at least one SSB burst, or a fourth value associated with no SSB bursts. In some aspects, the configuration indication may include a 2-bit field indicator comprised in MIB.

In aspects, a configuration indication of the set of configuration indications 606 may be indicative of a redundancy version (RV) cycling configuration associated with RMSI PDSCHs. The RV cycling configuration may be different than an RV indication included in RMSI PDCCHs associated with a scheduling of RMSI PDSCHs. In such aspects, the RV cycling configuration is associated with (i) the cross-beam combination for the RMSI over the RMSI PDSCHs of a SSB burst and with (ii) a cross-SSB burst combination for the RMSI over a corresponding RMSI PDSCH across a set of SSB bursts. In some aspects, the RV cycling configuration may be indicative of different RVs for each SSB of an SSB burst and for each SSB burst of a set of SSB bursts. In such aspects, the RV cycling configuration may include a rotation or pattern of the different RVs between each SSB of the SSB burst and between each SSB burst of the set of SSB bursts. The rotation of the different RVs may be in accordance with an RV cycling pattern, and the RV cycling pattern may be based on at least one of a number of RMSI periods, an SFN, or a configured period of time. In some aspects, the set of configuration indications 606 may comprise a MIB that is indicative of a SSB RSRP threshold configured at the UE 602. In such aspects, to receive, from the network node (e.g., the base station 604) and in accordance with the set of configuration indications 606, the set of PDCCHs 608, the UE 602 may be configured to receive the set of PDCCHs 608 as the cross-beam combination for the RMSI PDCCHs or as a cross-SSB burst combination for the RMSI PDCCHs based on at least one of the SSB RSRP threshold or a determination by the UE 602.

In aspects, where the set of configuration indications 606 comprises at least one of RMSI or OSI, the set of PDCCHs 608 may be associated with a multicast or a broadcast over a set of beams for the cross-beam combination. In such aspects, the set of PDCCHs 608 may be the cross-beam combination for the set of PDCCHs 608 associated with a multicast over a subset of the set of beams.

The UE 602 may be configured to combine (at 610) the set of PDCCHs 608 for a cross-beam combination or a cross-SSB burst combination based at least on the set of configuration indications 606. As noted herein, the UE 602 may be configured to combine (at 610) the set of PDCCHs 608 for a cross-beam combination or a cross-SSB burst combination based on at least one of the SSB RSRP threshold or a determination by the UE 602.

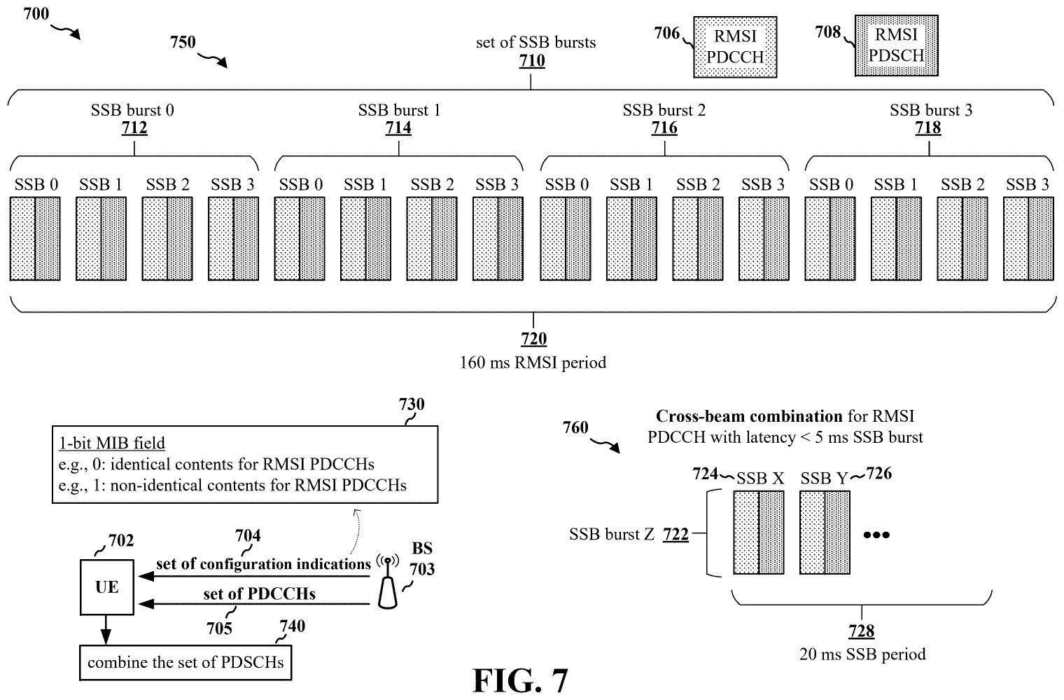

FIG. 7 is a diagram 700 illustrating examples of cross-beam RMSI PDxCH combinations, in various aspects. Diagram 700 shows a configuration 750 for a set of SSB bursts 710 and a cross-beam combination 760 configuration for an SSB burst Z 722 in the context of a UE 702 that communicates with a base station 703 (e.g., a network node; a gNB, etc.) and receives a set of configuration indications 704 and a set of PDCCHs 705, as described herein.

Referring to the configuration 750, the set of PDCCHs 705 may comprise the set of SSB bursts 710 over an RMSI period 720 (e.g., 160 ms). The set of SSB bursts 710 is shown, by way of example and for illustration, as including four SSB bursts (e.g., an SSB burst 0 712, an SSB burst 1 714, an SSB burst 2 716, an SSB burst 3 718), although aspects include other numbers of SSB bursts. Each of the SSB burst 0 712, the SSB burst 1 714, the SSB burst 2 716, and the SSB burst 3 718 may each include four SSBs (e.g., an SSB 0, and SSB 1, an SSB 2, an SSB 3), which in turn may each include an RMSI PDCCH of RMSI PDCCHs 706 and an RMSI PDSCH 708 (or in aspects, a PDCCH and a PDSCH, generally).

Referring to the cross-beam combination 760 configuration, the set of PDCCHs 705 may comprise the SSB burst Z 722 over an SSB period 728 (e.g., 20 ms). The SSB burst Z 722 may be an example of a given SSB burst comprising a set of SSBs (e.g., an SSB X 724, an SSB Y 726, etc.), for which the cross-beam combination 760 for RMSI PDCCHs may have a latency less than 5 ms for SSBs of the SSB burst Z 722.

As described herein, a set of configuration indications (e.g., the set of configuration indications 704) may include an indication (e.g., an indication 730) that may be indicative of whether contents of the RMSI PDCCHs 706 are identical across SSBs within the SSB bursts (e.g., the SSB burst 0 712, the SSB burst 1 714, the SSB burst 2 716, the SSB burst 3 718, the SSB burst Z 722). In aspects, the indication 730, to facilitate the cross-beam RMSI PDCCH combining, may include a 1-bit MIB field that indicates to the UE 802 that the contents of the RMSI PDCCHs 706 are identical across the SSBs within an SSB burst (e.g., the SSB burst 0 712, the SSB burst 1 714, the SSB burst 2 716, the SSB burst 3 718, the SSB burst Z 722). Generally, RMSI PDCCHs may not combinable across SSBs due to the different contents therein, however, aspects herein provide for identical contents of the RMSI PDCCHs 706 to enable cross-beam RMSI PDxCH combining. In prior solutions, the RMSI PDCCHs 706 may indicate different RVs, FDRAs/TDRAs, etc., across the SSBs in a given SSB burst, which would prevent combining of the RMSI PDCCHs 706 across the SSBs. In the aspects herein, to facilitate the cross-beam RMSI PDCCH combining, the 1-bit MIB field (e.g., the indication 730) may indicate to the UE 702 one of the two value options [0, 1]: 0, contents of the RMSI PDCCHs 706 are identical across the SSBs (e.g., the SSB 0, the SSB 1, the SSB 2, the SSB 3; the SSB X, the SSB Y, etc.); 1, contents of the RMSI PDCCHs 706 are not identical across the SSBs and fallback to a default 5G NR configuration is utilized (e.g., the UE 702 may assume nothing about the contents of the RMSI PDCCHs 706 across the SSBs). In some aspects, the indications for bit values of [0, 1] may be switched.

In aspects, if the RMSI PDCCHs 706 are combinable across SSBs, the UE 702 may be configured to combine (at 740) (e.g., perform the cross-beam RMSI PDCCH combining) the RMSI PDCCHs 706 (e.g., the set of PDCCHs 705) within a given SSB burst (e.g., with a latency of less than 5 ms). In contrast, cross-SSB burst RMSI PDCCH combining in prior solutions incurs a latency of at least 20 ms for each RMSI PDxCH combination.

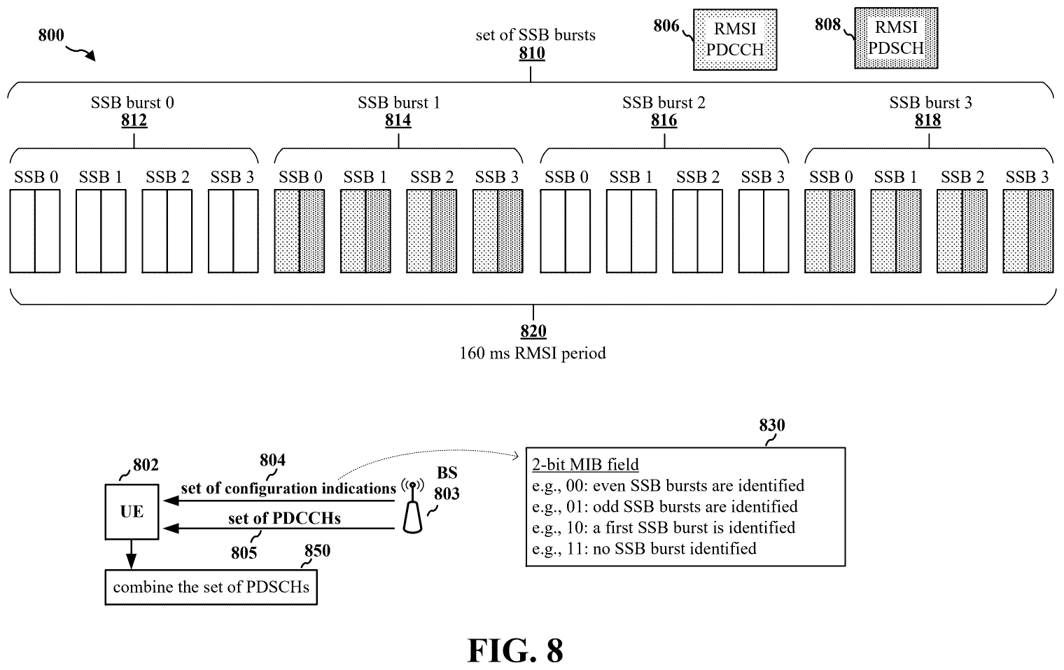

FIG. 8 is a diagram 800 illustrating examples of cross-beam RMSI PDxCH combinations for SSB bursts, in various aspects. Diagram 800 shows a set of SSB bursts 810 in the context of a UE 802 that communicates with a base station 803 (e.g., a network node; a gNB, etc.) and receives a set of configuration indications 804 and a set of PDCCHs 805, as described herein.

In aspects, a network node, e.g., the base station 803, a gNB, etc., may also indicate to a UE, e.g., the UE 802, the identifier(s) of SSB bursts within an RMSI period where the RMSI PDCCH transmission takes place so that the UE 802 combine the RMSI PDCCHs across the SSBs in the correct SSB burst.

In the diagram 800, the set of PDCCHs 805 may comprise the set of SSB bursts 810 over an RMSI period 820 (e.g., 160 ms). The set of SSB bursts 810 is shown, by way of example and for illustration, as including four SSB bursts (e.g., an SSB burst 0 812, an SSB burst 1 814, an SSB burst 2 816, an SSB burst 3 818), although aspects include other numbers of SSB bursts. In the illustrated aspect, each of the SSB burst 1 814 and the SSB burst 3 818 may each include four SSBs (e.g., an SSB 0, and SSB 1, an SSB 2, an SSB 3), which in turn may each include an RMSI PDCCH of RMSI PDCCHs 806 and an RMSI PDSCH 808 (or in aspects, a PDCCH and a PDSCH, generally), while the SSB burst 0 812 and the SSB burst 2 816 do not include the RMSI PDCCH 806 and the RMSI PDSCH 808.

As described herein, a set of configuration indications (e.g., the set of configuration indications 804) may include an indication (e.g., an indication 830) that may be indicative of which SSB burst(s) within the RMSI period 820 where the RMSI PDCCH transmission(s) takes place. In aspects, the indication 830, to facilitate the cross-beam RMSI PDCCH combining, may include a 2-bit MIB field that indicates to the UE 802 the correct SSBs. As a non-limiting example, the 2-bit MIB field of the indication 830 may indicate to the UE one of the four value options [00, 01, 10, 11]: 00, the RMSI PDCCHs 806 are transmitted every even SSB burst within the RMSI period (e.g., for the SSB burst 0 812 and the SSB burst 2 816); 01, the RMSI PDCCHs 806 are transmitted every odd SSB bursts within the RMSI period 820 (e.g., as shown for the SSB burst 1 814 and the SSB burst 3 818); 10, the RMSI PDCCHs 806 are transmitted every first SSB burst within the RMSI period 820 (e.g., for the SSB burst 0 812); 11, no SSB burst is identified and fallback to a default 5G NR configuration is utilized (e.g., the UE 802 may assume nothing about the SSB bursts within the RMSI period 820 as to where the RMSI PDCCH transmission(s) takes place). While the indication 830 is shown by way of example, aspects herein also include other combinations of SSBs for the indication 830, as well as the values shown for the indication 830 corresponding different identifications than shown (e.g., the value 00 may correspond to odd SSB bursts, the first SSB burst, etc.).

The UE 802 may thus be configured to combine (at 850) the RMSI PDCCHs 806 (e.g., the set of PDCCHs 805) across the SSBs of the SSB bursts (e.g., as shown for the SSB burst 1 814 and the SSB burst 3 818) in one (or more) SSB bursts indicated by the other indication described above for FIG. 7 (e.g., the indication 730 that indicates contents of the RMSI PDCCHs 706 are identical across the SSBs) provided that the contents of the RMSI PDCCHs 806 are identical across the SSBs within an SSB burst as indicated by the other indication, and based at least one the set of configuration indications 804.

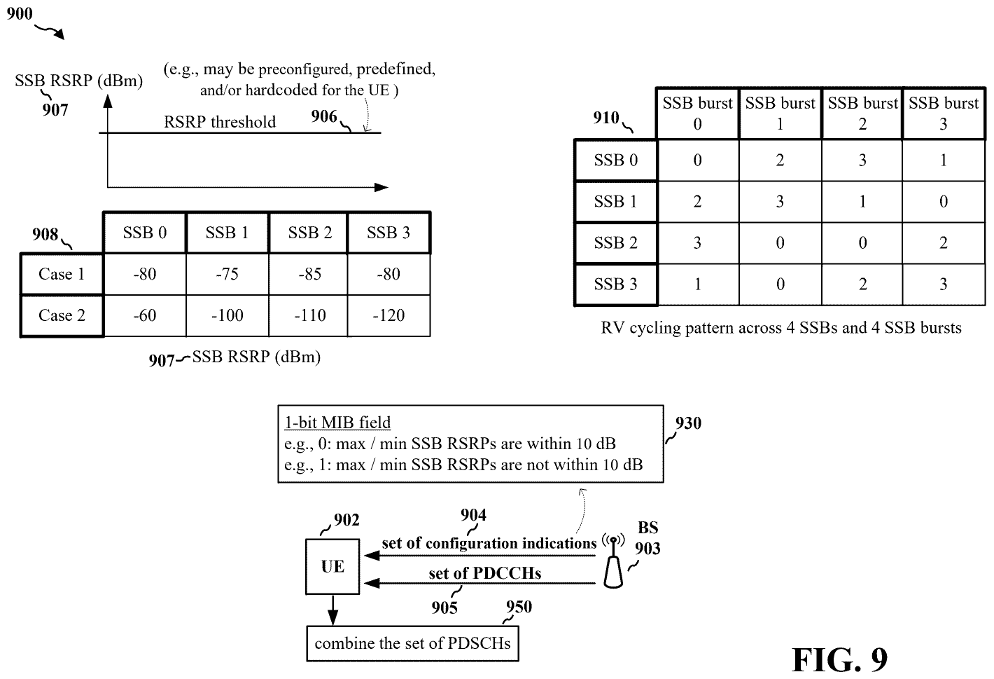

FIG. 9 is a diagram 900 illustrating examples of cross-beam RMSI PDxCH combinations with RV cycling pattern configurations, in various aspects. Diagram 900 shows an SSB RSRP threshold 906 for SSB RSRPs 907 (e.g., in dBm) received by the UE 902 and an RV cycling configuration 910 for a set of SSB bursts and a set of SSBs in the context of a UE 902 that communicates with a base station 903 (e.g., a network node; a gNB, etc.) and receives a set of configuration indications 904 and a set of PDCCHs 905, as described herein.

In aspects, a network node, e.g., the base station 903, a gNB, etc., may also indicate to a UE, e.g., the UE 902, the SSB RSRP threshold 906 for the SSB RSRP 907 of received SSBs, as described herein. As noted herein, the incremental redundancy RMSI PDSCH combining may not be performed when the RMSI PDCCHs indicate identical RVs. However, aspects herein provide for the RVs of the RMSI PDSCHs to be different to carry out the incremental redundancy RMSI PDSCH combining, while the RMSI PDCCHs are otherwise indicate as having identical contents. Aspects to enable such different RVs for the RMSI PDSCHs, and to vary the RVs of the RMSI PDSCHs, while keeping the contents of the RMSI PDCCHs identical, are described.

As an example, aspects provide for RV cycling patterns that may be preconfigured, predefined, and/or hardcoded for the UE 902 (e.g., according to a specification/standard) rather than using the RV fields indicated by the RMSI PDCCHs. Such aspects may be enabled or disabled by an indication 930 of the set of configuration indications 904, e.g., by a 1-bit MIB field associated with SSB RSRP cases 908.

As an illustrative example of the RV cycling pattern shown for the RV cycling configuration 910, where the UE 902 may favor either cross-beam or cross-SSB burst RMSI PDSCH combining, the SSB RSRP cases 908 include a first case (Case 1) and a second case (Case 2). In Case 1, if the SSB RSRPs are equal, or are approximately equal in accordance with the SSB RSRP threshold 906, across the SSBs within an SSB burst, the UE 902 may be configured to determine to perform cross-beam RMSI PDSCH combining. For instance, cross-beam RMSI PDSCH combining across SSB 0 to SSB 3 of an SSB burst may be performed by the UE 902. On the other hand, in Case 2, if the SSB RSRPs are unequal or are approximately unequal in accordance with the SSB RSRP threshold 906, across the SSBs within a given SSB burst, the UE 902 may be configured to determine to perform cross-SSB burst RMSI PDSCH combining. For instance, cross-SSB burst RMSI PDSCH combining for a given SSB X (SSB 0, SSB 1, SSB 2, or SSB 3) across the SSB burst 0 to the SSB burst 3 may be performed by the UE 902. Accordingly, the RV cycling pattern of the RV cycling configuration 910 accommodates both the spatial-/frequency-, e.g., cross-beam, and time-domain, e.g., cross-SSB burst, RV cycling. As one example, the RV cycling configuration 910, as shown, is the same for SSB burst 0 to SSB burst 3 and for SSB 0 to SSB 3. That is, for the RV cycling pattern of the RV cycling configuration 910, the UE 902 may carry out the incremental redundancy RMSI PDSCH combining in either the cross-beam or cross-SSB burst fashion.

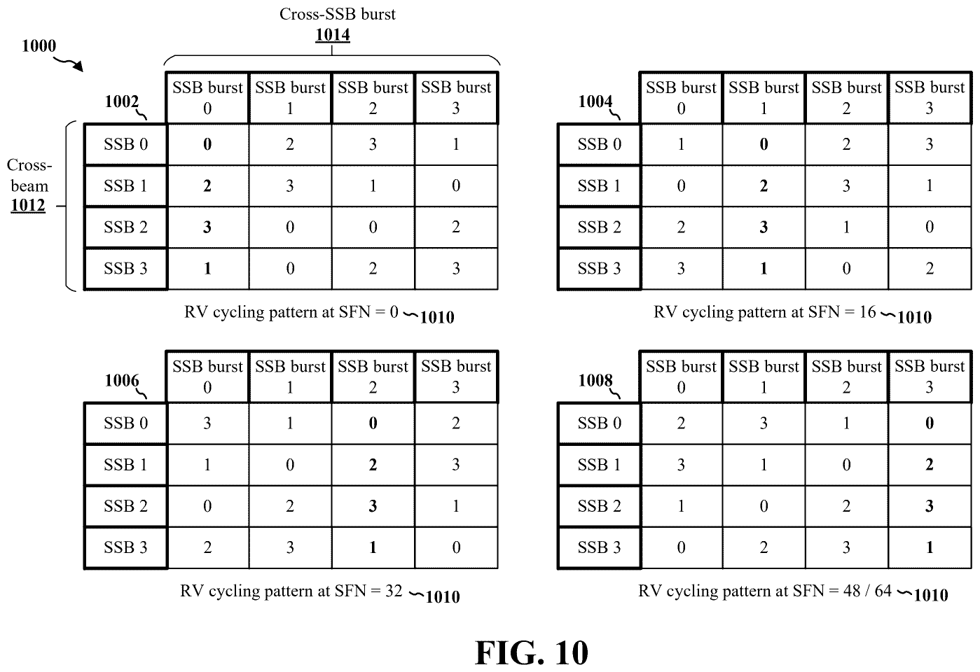

However, the RV cycling pattern described above for diagram 900 may be unfair for SSB burst 1 and SSB burst 3 because the RV cycling pattern begins with RV 2 and RV 1, which are not self-decodable, e.g., the RMSI PDSCHs multiplexed with SSB 0 associated with SSB bursts 1 and 3 are not self-decodable regardless of the signal-to-noise ratio (SNR). FIG. 10, described below, may be a further aspect herein by which this issue is remediated via a fairness rotation.

With reference to the SSB RSRP threshold 906, for the UE 902 to determine whether to carry out the RMSI PDSCH combining as cross-beam or cross-SSB burst, the base station 903 may be configured to indicate to the UE 902 the SSB RSRP threshold 906 for determining whether the SSB RSRP(s) 907 are equal or unequal across the SSBs (or approximately equal/unequal). In aspects, the 1-bit MIB field of the indication 930 may indicate to the UE 902 the SSB RSRP threshold 906. For example, the 1-bit MIB field may indicate to the UE 902 one of two value options [0, 1]: 0, if the maximum and minimum SSB RSRPs are within 10 dB of each other, the UE 902 may perform cross-beam RMSI PDSCH combining; 1, if the maximum and minimum SSB RSRPs are not within 10 dB, the UE 902 may perform cross-beam RMSI PDSCH combining. While the indication 930 is shown by way of example, aspects herein also include other values for the SSB RSRP threshold 906 of the indication 930, as well as the values shown for the indication 930 corresponding different identifications than shown (e.g., the values 0 and 1 may switched).

Accordingly, the UE 902 may be configured to combine (at 950) the set of PDCCHs 905 by a cross-beam combination or a cross-SSB burst combination, e.g., based at least on the set of configuration indications 904.

FIG. 10 is a diagram 1000 illustrating examples of RV cycling pattern configurations with rotation, in various aspects. Diagram 1000 may be an aspect of diagram 900 in FIG. 9, described above, and shows an RV cycling pattern 1002, an RV cycling pattern 1004, an RV cycling pattern 1006, and an RV cycling pattern 1008.

As noted above with respect to FIG. 9, an RV cycling pattern that is static or non-rotational may be unfair for some SSB bursts as the RV cycling pattern may begin with non-self-decodable RVs for some SSB bursts. Aspects provide for fairness across the SSB bursts by enabling RV cycling pattern configurations with rotation, as shown in diagram 1000. As an example, for fairness across the SSB bursts, the RV cycling pattern table shown in the RV cycling pattern 1004 is rotated, e.g., in a row-wise order. In aspects, the RV cycling pattern rotation may be based on at least one of a number of RMSI periods, a SFN 1010 (as shown by way of example), or a configured period of time. For instance, every predefined duration, e.g., a number N of RMSI periods, the RV cycling pattern may be rotated (e.g., the RV cycling pattern table rotates in a column-wise order every 16 SFNs, e.g., every RMSI period of 160 ms.

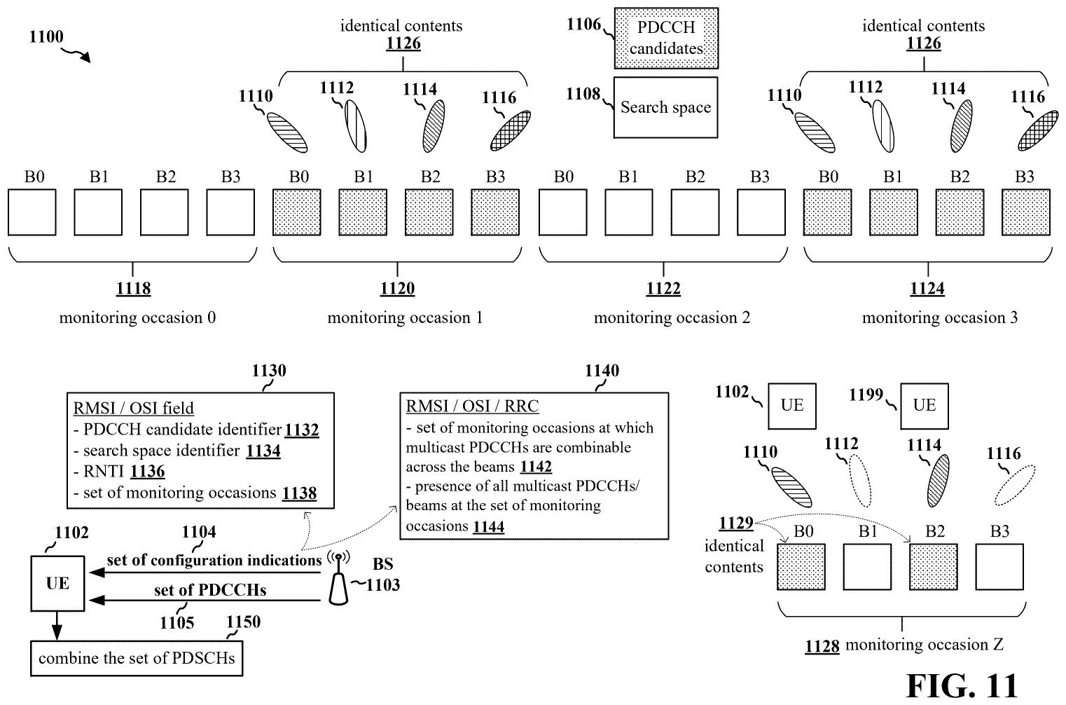

FIG. 11 is a diagram 1100 illustrating examples of cross-beam PDxCH combinations for multicasting/broadcasting, in various aspects. Diagram 1100 is shown in the context of a UE 1102 that communicates with a base station 1103 (e.g., a network node; a gNB, etc.) and receives a set of configuration indications 1104 and a set of PDCCHs 1105, as described herein.

As noted herein, aspects include other types of PDCCH cross-beam combinations, in addition to RMSI PDxCH cross-beam combinations, such as for multicast/broadcast signaling. Aspects enable the UE 1102 to perform multicast/broadcast PDCCH cross-beam combinations within monitoring occasions by providing the UE 1102, from the base station 1103, with an indication 1130 (of the set of configuration indications 1104) that indicates combinable candidate patterns, including but not limited to, a PDCCH candidate identifier 1132, a search space identifier 1134 of a search space 1108, RNTI 1136, and/or a particular monitoring occasion(s) (e.g., a set of monitoring occasions 1138) at which PDCCH candidates 1106 are combinable across a set of beams (e.g., a beam B0 1110, a beam B1 1112, a beam B2 1114, a beam B3 1116) for the set of monitoring occasions 1138 (e.g., a monitoring occasion 0 1118, a monitoring occasion 1 1120, a monitoring occasion 2 1122, a monitoring occasion 3 1124) associated with search space 1108. In aspects, the set of configuration indications 1104 may indicate to the UE 1102 that the PDCCH candidates 1106 include identical contents 1126, e.g., at the monitoring occasion 1 1120 and the monitoring occasion 3 1124.

For example, the broadcast/multicast of the PDCCH candidates 1106 may include the identical content 1126 across the set of beams (e.g., the beam B0 1110, the beam B1 1112, the beam B2 1114, the beam B3 1116) at particular monitoring occasions (e.g., at the monitoring occasion 1 1120 and the monitoring occasion 3 1124) for a given one of the PDCCH candidates 1106 in the following scenarios: a Type0B-CSS configured by searchSpaceMCCH (multicast control channel) and searchSpaceMTCH (multicast traffic channel) scrambled with the MCCH-RNTI, a Type2-CSS configured by pagingSearchSpace in PDCCH-ConfigCommon scrambled with the P-RNTI, e.g., a paging PDCCH, a Type2A-CSS configured by pei-SearchSpace in pei-ConfigBWP scrambled with the PEI-RNTI, e.g., a permanent equipment identifier (PEI) PDCCH, and a Type3-CSS configured by SearchSpace in pdcch-ConfigMulticast scrambled with the G-RNTI, e.g., a multicast PDCCH. The UE 1102 may be configured to receive, and the base station 1103 may be configured to transmit, provide, configure the UE 1102 with, an indication 1130 (e.g., of the set of configuration indications 1104) of SI (e.g., RMSI/SIB1; OSI/SIB2, SIB3, SIB4, etc.) that indicates the combinable candidate pattern(s) including but not limited to, a PDCCH candidate identifier 1132, a search space identifier 1134 of a search space 1108, RNTI 1136, and/or a particular monitoring occasion(s) (e.g., a set of monitoring occasions 1138) at which the PDCCH candidates 1106 are combinable.

In some aspects, the multicast signaling may be transmitted/provided by the base station 1103, and received by the UE 1102, over a subset of the set of beams (e.g., a subset of the beam B0 1110, the beam B1 1112, the beam B2 1114, the beam B3 1116), e.g., the beam B0 1110 and the beam B2 1114, as shown, where the subset may include fewer beams than the set. In such scenarios, the UE 1102 may be aware of the multicast PDCCH beamformed by the beam B0 1110, but may not be aware of a multicast PDCCH beamformed for a different UE, a UE 1199, e.g., by the beam B2 1114.

Aspects enable the base station 1103 to transmit/provide/configure the UE 1102 with an indication 1140, e.g., via RMSI, OSI, and/or RRC signaling, which indicates a particular monitoring occasion(s) (e.g., a set of monitoring occasions 1142 such as a monitoring occasion Z 1128) at which the multicast PDCCHs are combinable across the beams and a presence 1144 of all the multicast PDCCHs and beams at the particular monitoring occasion(s) to facilitate the cross-beam multicast PDCCH combining. For example, when the base station 1103 transmits/provides the multicast of the PDCCH candidates 1106 with identical content 1129 to the UE 1102 and the UE 1199 over the beam B0 1110 and the beam B2 1114 at the monitoring occasion Z 1128, aspects provide for the UE 1102 and the UE 1199 to be aware of both the beam B0 1110 and the beam B2 1114. In contrast, prior solutions provide for the UE 1102 and the UE 1199 to be aware of the beam B0 1110 and the beam B2 1114, respectively, but not both. As one example, aspects provide for the indication 1140 to indicate the UE 1102 that the beam B2 is present and includes a PDCCH candidate of the PDCCH candidates 1106 at the monitoring occasion Z 1128.

In aspects, the base station 1103 may be configured to transmit/provide/configure the UE 1102 with the indication 1140 about the presence of all the multicast PDCCHs and beams at a particular monitoring occasion through, e.g., RMSI and/or OSI when RRC_IDLE or RRC_INACTIVE, e.g., RRC signaling when RRC_CONNECTED.

Accordingly, the UE 1102 and the UE 1199 may be configured to combine (at 1150) the multicast PDCCHs (e.g., the set of PDCCHs 1105; the PDCCH candidates 1106) across the beam B0 1110 and the beam B2 1114 at the monitoring occasion Z 1128, e.g., based at least on the set of configuration indications 1104.

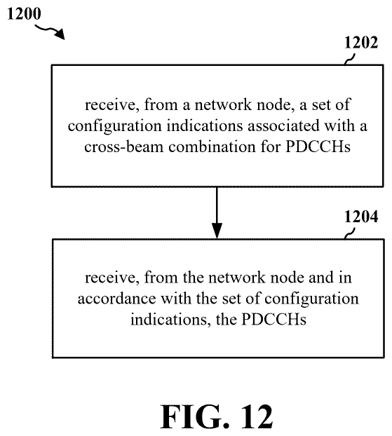

FIG. 12 is a flowchart 1200 of a method of wireless communication. The method may be performed by a UE (e.g., the UE 104, 602, 702, 802, 902, 1102, 1199; the apparatus 1404). The method may be for cross-beam RMSI PDxCH combining. The method may enable improved coverage and reduced bottlenecks for RMSI PDxCHs by indicating to a UE that contents of RMSI PDCCHs are identical across SSB within an SSB burst, provide for cross-beam combinations even when PDCCH contents are identical by utilizing RV cycling configurations applicable to spatial- and time-domains and that differ from PDCCH RVs, and enable UEs to combine broadcast/multicast PDCCHs across beams within a monitoring occasion by providing indications of combinable candidate patterns for beams to a UE.

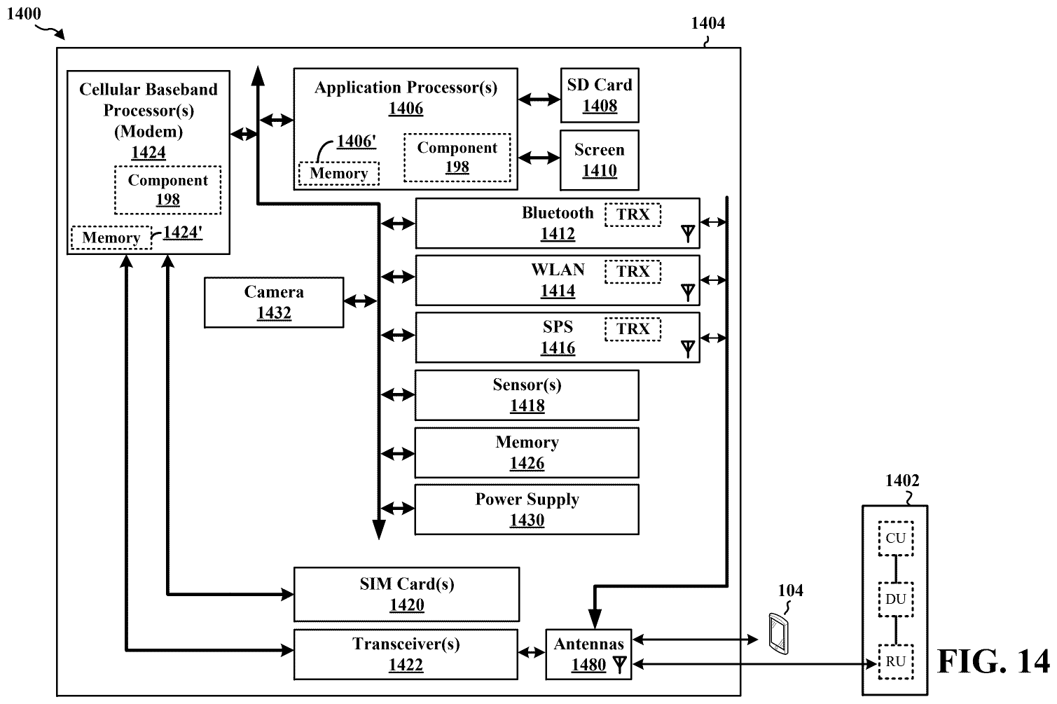

At 1202, the UE receives, from a network node, a set of configuration indications associated with a cross-beam combination for PDCCHs. As an example, the reception may be performed by one or more of the component 198, the transceiver(s) 1422, and/or the antennas 1480 in FIG. 14. FIG. 6 illustrates, in the context of FIGS. 7, 8, 9, 10, 11, an example of the UE 602 receiving such a set of configuration indications from a network node (e.g., the base station 604).

The UE 602 may be configured to receive, and the base station 604 may be configured to transmit/provide/configure the UE 602 with, a set of configuration indications 606 (e.g., 704 in FIG. 7; 804 in FIG. 8; 904 in FIG. 9; 1104 in FIG. 11). In aspects, the UE 602 may be configured to receive, from a network node (e.g., the base station 604), the set of configuration indications 606 (e.g., 704 in FIG. 7; 804 in FIG. 8; 904 in FIG. 9; 1104 in FIG. 11) associated with a cross-beam combination (e.g., 760 in FIG. 7; 814, 818 in FIG. 8; 1012 in FIG. 10) for PDCCHs (e.g., a set of PDCCHs 608 (e.g., 705 in FIG. 7; 805 in FIG. 8; 905 in FIG. 9; 1105 in FIG. 11)).

At 1204, the UE receives, from the network node and in accordance with the set of configuration indications, the PDCCHs. As an example, the reception may be performed by one or more of the component 198, the transceiver(s) 1422, and/or the antennas 1480 in FIG. 14. FIG. 6 illustrates, in the context of FIGS. 7, 8, 9, 10, 11, an example of the UE 602 receiving such PDCCHs from a network node (e.g., the base station 604).

The UE 602 may be configured to receive, and the base station 604 may be configured to transmit/provide, the set of PDCCHs 608 (e.g., 705 in FIG. 7; 805 in FIG. 8; 905 in FIG. 9; 1105 in FIG. 11). In aspects, the UE 602 may be configured to receive, from the network node (e.g., the base station 604) and in accordance with the set of configuration indications 606 (e.g., 704 in FIG. 7; 804 in FIG. 8; 904 in FIG. 9; 1104 in FIG. 11), the PDCCHs (e.g., the set of PDCCHs 608 (e.g., 705 in FIG. 7; 805 in FIG. 8; 905 in FIG. 9; 1105 in FIG. 11)). In aspects, the set of PDCCHs 608 (e.g., 705 in FIG. 7; 805 in FIG. 8; 905 in FIG. 9; 1105 in FIG. 11) may comprise RMSI, and the RMSI may be associated with the cross-beam combination (e.g., 760 in FIG. 7; 814, 818 in FIG. 8; 1012 in FIG. 10) for RMSI PDCCHs (e.g., 706 in FIG. 7; 806 in FIG. 8; 1106 in FIG. 11) (e.g., as the set of PDCCHs 608 (e.g., 705 in FIG. 7; 805 in FIG. 8; 905 in FIG. 9; 1105 in FIG. 11)). In some aspects, the set of configuration indications 606 (e.g., 704 in FIG. 7; 804 in FIG. 8; 904 in FIG. 9; 1104 in FIG. 11) may comprise at least one of RMSI or OSI (e.g., 1130 in FIG. 11). In such aspects, the set of configuration indications 606 (e.g., 704 in FIG. 7; 804 in FIG. 8; 904 in FIG. 9; 1104 in FIG. 11) may be indicative of at least one of a PDCCH candidate identifier (e.g., 1132 in FIG. 11), a search space identifier (e.g., 1134 in FIG. 11) associated with a search space (e.g., 1108 in FIG. 11), a RNTI (e.g., 1136 in FIG. 11), or a set of monitoring occasions (e.g., 1120, 1124, 1138 in FIG. 11) associated with combinable PDCCH candidates (e.g., 1106 in FIG. 11) for the cross-beam combination (e.g., 760 in FIG. 7; 814, 818 in FIG. 8; 1012 in FIG. 10). In some aspects, the set of configuration indications 606 (e.g., 704 in FIG. 7; 804 in FIG. 8; 904 in FIG. 9; 1104 in FIG. 11) may comprise at least one of RMSI or OSI or RRC signaling (e.g., 1140 in FIG. 11), and the set of configuration indications 606 (e.g., 704 in FIG. 7; 804 in FIG. 8; 904 in FIG. 9; 1104 in FIG. 11) may be indicative of the set of monitoring occasions (e.g., 1120, 1124, 1128, 1142 in FIG. 11) with identical contents (e.g., 1126 in FIG. 11) and a presence (e.g., 1144 in FIG. 11) of each multicast PDCCH (e.g., 1106 in FIG. 11) and associated beam (e.g., 1110, 1112, 1114, 1116 in FIG. 11) at ones of the set of monitoring occasions (e.g., 1120, 1124, 1128, 1142 in FIG. 11).

In aspects, a configuration indication of the set of configuration indications 606 (e.g., 704 in FIG. 7; 804 in FIG. 8; 904 in FIG. 9; 1104 in FIG. 11) may be indicative of whether contents of the RMSI PDCCHs (e.g., 706 in FIG. 7; 806 in FIG. 8; 1106 in FIG. 11) are identical (e.g., 730 in FIG. 7; 1126 in FIG. 11) across SSBs (e.g., SSB 0-SSB 4 in FIGS. 7, 8) within an SSB burst (e.g., 710, 712, 714, 716, 718, 722 in FIG. 7; 810, 812, 814, 816, 818 in FIG. 8). In aspects, such a configuration indication may be configured for a first value (e.g., 0 of 730 in FIG. 7) associated with the contents of the RMSI PDCCHs (e.g., 706 in FIG. 7; 806 in FIG. 8; 1106 in FIG. 11) being identical (e.g., 730 in FIG. 7) across the SSBs (e.g., SSB 0-SSB 4, 724, 726, in FIGS. 7, 8) within the SSB burst (e.g., 710, 712, 714, 716, 718, 722 in FIG. 7; 812, 814, 816, 818 in FIG. 8) or a second value (e.g., 1 of 730 in FIG. 7) associated with the contents of the RMSI PDCCHs (e.g., 706 in FIG. 7; 806 in FIG. 8; 1106 in FIG. 11) being non-identical (e.g., 730 in FIG. 7) across the SSBs (e.g., SSB 0-SSB 4, 724, 726, in FIGS. 7, 8) within the SSB burst (e.g., 710, 712, 714, 716, 718, 722 in FIG. 7; 810, 812, 814, 816, 818 in FIG. 8). In aspects, the configuration indication may include a 1-bit field indicator comprised in a MIB (e.g., 730 in FIG. 7).

In aspects, a configuration indication of the set of configuration indications 606 (e.g., 704 in FIG. 7; 804 in FIG. 8; 904 in FIG. 9; 1104 in FIG. 11) may be indicative of contents of the RMSI PDCCHs (e.g., 706 in FIG. 7; 806 in FIG. 8; 1106 in FIG. 11) being identical across SSBs (e.g., SSB 0-SSB 4, 724, 726, in FIGS. 7, 8) for at least one SSB burst (e.g., 712, 714, 716, 718, 722 in FIG. 7; 812, 814, 816, 818 in FIG. 8) of a set of SSB bursts (e.g., 710 in FIG. 7; 810 in FIG. 8). In such aspects, the configuration indication may be configured for a first value (e.g., 00 of 830 in FIG. 8) associated with each even numbered SSB as the at least one SSB burst (e.g., 712, 714, 716, 718, 722 in FIG. 7; 812, 814, 816, 818 in FIG. 8), a second value (e.g., 01 of 830 in FIG. 8) associated with each odd numbered SSB as the at least one SSB burst (e.g., 712, 714, 716, 718, 722 in FIG. 7; 812, 814, 816, 818 in FIG. 8), a third value (e.g., 10 of 830 in FIG. 8) associated with a first SSB burst as the at least one SSB burst (e.g., 712, 714, 716, 718, 722 in FIG. 7; 812, 814, 816, 818 in FIG. 8), or a fourth value (e.g., 11 of 830 in FIG. 8) associated with no SSB bursts. In some aspects, the configuration indication may include a 2-bit field indicator comprised in MIB (e.g., 830 in FIG. 8).

In aspects, a configuration indication of the set of configuration indications 606 (e.g., 704 in FIG. 7; 804 in FIG. 8; 904 in FIG. 9; 1104 in FIG. 11) may be indicative of a redundancy version (RV) cycling configuration (e.g., 908, 910 in FIG. 9) associated with RMSI PDSCHs (e.g., 708 in FIG. 7; 808 in FIG. 8). The RV cycling configuration (e.g., 908, 910 in FIG. 9) may be different than an RV indication included in RMSI PDCCHs (e.g., 706 in FIG. 7; 806 in FIG. 8; 1106 in FIG. 11) associated with a scheduling of RMSI PDSCHs (e.g., 708 in FIG. 7; 808 in FIG. 8). In such aspects, the RV cycling configuration (e.g., 908, 910 in FIG. 9) is associated with (i) the cross-beam combination (e.g., 760 in FIG. 7; 814, 818 in FIG. 8; 1012 in FIG. 10) for the RMSI over the RMSI PDSCHs (e.g., 708 in FIG. 7; 808 in FIG. 8) of a SSB burst (e.g., 712, 714, 716, 718, 722 in FIG. 7; 812, 814, 816, 818 in FIG. 8) and with (ii) a cross-SSB burst combination (e.g., 512 in FIG. 5; 1014 in FIG. 10) for the RMSI over a corresponding RMSI PDSCH (e.g., 708 in FIG. 7; 808 in FIG. 8) across a set of SSB bursts (e.g., 710 in FIG. 7; 810 in FIG. 8). In some aspects, the RV cycling configuration (e.g., 908, 910 in FIG. 9) may be indicative of different RVs (e.g., 0, 1, 2, 3 in FIGS. 9, 10) for each SSB (e.g., SSB 0-SSB 4, 724, 726, in FIGS. 7, 8) of an SSB burst (e.g., 712, 714, 716, 718, 722 in FIG. 7; 812, 814, 816, 818 in FIG. 8) and for each SSB burst (e.g., 712, 714, 716, 718, 722 in FIG. 7; 812, 814, 816, 818 in FIG. 8) of a set of SSB bursts (e.g., 710 in FIG. 7; 810 in FIG. 8). In such aspects, the RV cycling configuration (e.g., 908, 910 in FIG. 9) may include a rotation or pattern (e.g., 1002, 1004, 1006, 1008, 1010 in FIG. 10) of the different RVs (e.g., 0, 1, 2, 3 in FIGS. 9, 10) between each SSB (e.g., SSB 0-SSB 4, 724, 726, in FIGS. 7, 8) of the SSB burst (e.g., 712, 714, 716, 718, 722 in FIG. 7; 812, 814, 816, 818 in FIG. 8) and between each SSB burst (e.g., 712, 714, 716, 718, 722 in FIG. 7; 812, 814, 816, 818 in FIG. 8) of the set of SSB bursts (e.g., 710 in FIG. 7; 810 in FIG. 8). The rotation (e.g., 1002, 1004, 1006, 1008, 1010 in FIG. 10) of the different RVs (e.g., 0, 1, 2, 3 in FIGS. 9, 10) may be in accordance with an RV cycling pattern (e.g., 1002, 1004, 1006, 1008, 1010 in FIG. 10), and the RV cycling pattern (e.g., 1002, 1004, 1006, 1008, 1010 in FIG. 10) may be based on at least one of a number of RMSI periods, an SFN, or a configured period of time. In some aspects, the set of configuration indications 606 (e.g., 704 in FIG. 7; 804 in FIG. 8; 904 in FIG. 9; 1104 in FIG. 11) may comprise a MIB (e.g., 930 in FIG. 9) that is indicative of a SSB RSRP (e.g., 907 in FIG. 9) threshold (e.g., 906 in FIG. 9) configured at the UE 602. In such aspects, to receive, from the network node (e.g., the base station 604) and in accordance with the set of configuration indications 606 (e.g., 704 in FIG. 7; 804 in FIG. 8; 904 in FIG. 9; 1104 in FIG. 11), the set of PDCCHs 608 (e.g., 705 in FIG. 7; 805 in FIG. 8; 905 in FIG. 9; 1105 in FIG. 11), the UE 602 may be configured to receive the set of PDCCHs 608 (e.g., 705 in FIG. 7; 805 in FIG. 8; 905 in FIG. 9; 1105 in FIG. 11) as the cross-beam combination (e.g., 760 in FIG. 7; 814, 818 in FIG. 8; 1012 in FIG. 10) for the RMSI PDCCHs (e.g., 706 in FIG. 7; 806 in FIG. 8; 1106 in FIG. 11) or as a cross-SSB burst combination (e.g., 512 in FIG. 5; 1014 in FIG. 10) for the RMSI PDCCHs (e.g., 706 in FIG. 7; 806 in FIG. 8; 1106 in FIG. 11) based on at least one of the SSB RSRP (e.g., 907 in FIG. 9) threshold (e.g., 906 in FIG. 9) or a determination by the UE 602.

In aspects, where the set of configuration indications 606 (e.g., 704 in FIG. 7; 804 in FIG. 8; 904 in FIG. 9; 1104 in FIG. 11) comprises at least one of RMSI or OSI, the set of PDCCHs 608 (e.g., 705 in FIG. 7; 805 in FIG. 8; 905 in FIG. 9; 1105 in FIG. 11) may be associated with a multicast or a broadcast over a set of beams (e.g., 1110, 1112, 1114, 1116 in FIG. 11) for the cross-beam combination (e.g., 760 in FIG. 7; 814, 818 in FIG. 8; 1012 in FIG. 10). In such aspects, the set of PDCCHs 608 (e.g., 705 in FIG. 7; 805 in FIG. 8; 905 in FIG. 9; 1105 in FIG. 11) may be the cross-beam combination (e.g., 760 in FIG. 7; 814, 818 in FIG. 8; 1012 in FIG. 10) for the set of PDCCHs 608 (e.g., 705 in FIG. 7; 805 in FIG. 8; 905 in FIG. 9; 1105 in FIG. 11) associated with a multicast over a subset of the set of beams (e.g., 1110, 1114 in FIG. 11) with identical contents (e.g., 1129 in FIG. 11).

The UE 602 may be configured to combine (at 610) the set of PDCCHs 608 (e.g., 705 in FIG. 7; 805 in FIG. 8; 905 in FIG. 9; 1105 in FIG. 11) for a cross-beam combination (e.g., 760 in FIG. 7; 814, 818 in FIG. 8; 1012 in FIG. 10) or a cross-SSB burst combination (e.g., 512 in FIG. 5; 1014 in FIG. 10) based at least on the set of configuration indications 606 (e.g., 704 in FIG. 7; 804 in FIG. 8; 904 in FIG. 9; 1104 in FIG. 11). As noted herein, the UE 602 may be configured to combine (at 610) (e.g., 740 in FIG. 7; 850 in FIG. 8; 950 in FIG. 9; 1150 in FIG. 11) the set of PDCCHs 608 (e.g., 705 in FIG. 7; 805 in FIG. 8; 905 in FIG. 9; 1105 in FIG. 11) for a cross-beam combination (e.g., 760 in FIG. 7; 814, 818 in FIG. 8; 1012 in FIG. 10) or a cross-SSB burst combination (e.g., 512 in FIG. 5; 1014 in FIG. 10) based on at least one of the SSB RSRP (e.g., 907 in FIG. 9) threshold (e.g., 906 in FIG. 9) or a determination by the UE 602.

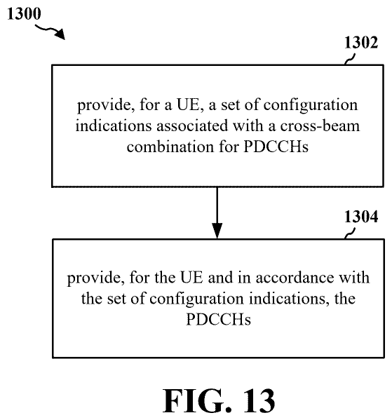

FIG. 13 is a flowchart 1300 of a method of wireless communication. The method may be performed by a network node, a base station, a gNB, etc. (e.g., the base station 102, 604, 703, 803, 903, 1103; the network entity 1402, 1502). The method may be for cross-beam RMSI PDxCH combining. The method may enable improved coverage and reduced bottlenecks for RMSI PDxCHs by indicating to a UE that contents of RMSI PDCCHs are identical across SSB within an SSB burst, provide for cross-beam combinations even when PDCCH contents are identical by utilizing RV cycling configurations applicable to spatial- and time-domains and that differ from PDCCH RVs, and enable UEs to combine broadcast/multicast PDCCHs across beams within a monitoring occasion by providing indications of combinable candidate patterns for beams to a UE.

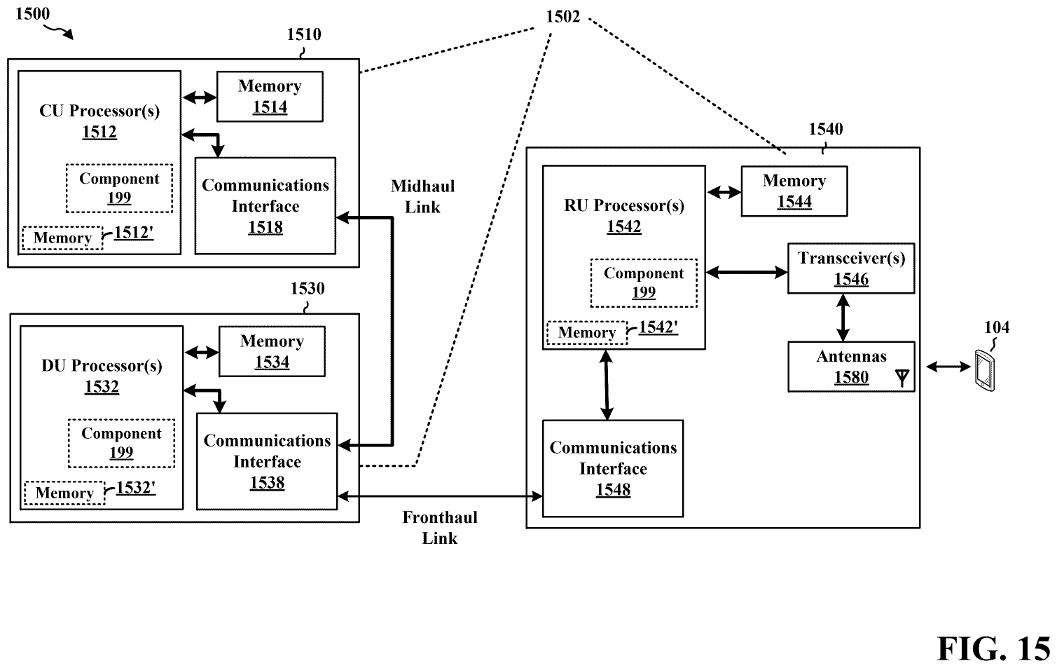

At 1302, the network node provides, for a UE, a set of configuration indications associated with a cross-beam combination for PDCCHs. As an example, the provision may be performed by one or more of the component 199, the transceiver(s) 1546, and/or the antennas 1580 in FIG. 15. FIG. 6 illustrates, in the context of FIGS. 7, 8, 9, 10, 11, an example of a network node (e.g., the base station 604) providing a UE (e.g., the UE 702) with such a set of configuration indications.

The base station 604 may be configured to transmit/provide/configure the UE 602 with, and the UE 602 may be configured to receive, a set of configuration indications 606 (e.g., 704 in FIG. 7; 804 in FIG. 8; 904 in FIG. 9; 1104 in FIG. 11). In aspects, the UE 602 may be configured to receive, from a network node (e.g., the base station 604), the set of configuration indications 606 (e.g., 704 in FIG. 7; 804 in FIG. 8; 904 in FIG. 9; 1104 in FIG. 11) associated with a cross-beam combination for PDCCHs (e.g., a set of PDCCHs 608 (e.g., 705 in FIG. 7; 805 in FIG. 8; 905 in FIG. 9; 1105 in FIG. 11)).

At 1304, the network node provides, for the UE and in accordance with the set of configuration indications, the PDCCHs. As an example, the provision may be performed by one or more of the component 199, the transceiver(s) 1546, and/or the antennas 1580 in FIG. 15. FIG. 6 illustrates, in the context of FIGS. 7, 8, 9, 10, 11, an example of a network node (e.g., the base station 604) providing a UE (e.g., the UE 702) with such PDCCHs.

The UE 602 may be configured to receive, and the base station 604 may be configured to transmit/provide, the set of PDCCHs 608. In aspects, the UE 602 may be configured to receive, from the network node (e.g., the base station 604) and in accordance with the set of configuration indications 606, the PDCCHs (e.g., the set of PDCCHs 608). In aspects, the set of PDCCHs 608 may comprise RMSI, and the RMSI may be associated with the cross-beam combination for RMSI PDCCHs (e.g., as the set of PDCCHs 608). In some aspects, the set of configuration indications 606 may comprise at least one of RMSI or OSI. In such aspects, the set of configuration indications 606 may be indicative of at least one of a PDCCH candidate identifier, a search space identifier, a RNTI, or a set of monitoring occasions associated with combinable PDCCH candidates for the cross-beam combination. In some aspects, the set of configuration indications 606 may be indicative of the set of monitoring occasions and a presence of each multicast PDCCH and associated beam at ones of the set of monitoring occasions.

In aspects, a configuration indication of the set of configuration indications 606 may be indicative of whether contents of the RMSI PDCCHs are identical across SSBs within an SSB burst. In aspects, such a configuration indication may be configured for a first value associated with the contents of the RMSI PDCCHs being identical across the SSBs within the SSB burst or a second value associated with the contents of the RMSI PDCCHs being non-identical across the SSBs within the SSB burst. In aspects, the configuration indication may include a 1-bit field indicator comprised in a MIB.

In aspects, a configuration indication of the set of configuration indications 606 may be indicative of contents of the RMSI PDCCHs being identical across SSBs for at least one SSB burst of a set of SSB bursts. In such aspects, the configuration indication may be configured for a first value associated with each even numbered SSB as the at least one SSB burst, a second value associated with each odd numbered SSB as the at least one SSB burst, a third value associated with a first SSB burst as the at least one SSB burst, or a fourth value associated with no SSB bursts. In some aspects, the configuration indication may include a 2-bit field indicator comprised in MIB.

In aspects, a configuration indication of the set of configuration indications 606 may be indicative of a redundancy version (RV) cycling configuration associated with RMSI PDSCHs. The RV cycling configuration may be different than an RV indication included in RMSI PDCCHs associated with a scheduling of RMSI PDSCHs. In such aspects, the RV cycling configuration is associated with (i) the cross-beam combination for the RMSI over the RMSI PDSCHs of a SSB burst and with (ii) a cross-SSB burst combination for the RMSI over a corresponding RMSI PDSCH across a set of SSB bursts. In some aspects, the RV cycling configuration may be indicative of different RVs for each SSB of an SSB burst and for each SSB burst of a set of SSB bursts. In such aspects, the RV cycling configuration may include a rotation of the different RVs between each SSB of the SSB burst and between each SSB burst of the set of SSB bursts. The rotation of the different RVs may be in accordance with an RV cycling pattern, and the RV cycling pattern may be based on at least one of a number of RMSI periods, an SFN, or a configured period of time. In some aspects, the set of configuration indications 606 may comprise a MIB that is indicative of a SSB RSRP threshold configured at the UE 602. In such aspects, to receive, from the network node (e.g., the base station 604) and in accordance with the set of configuration indications 606, the set of PDCCHs 608, the UE 602 may be configured to receive the set of PDCCHs 608 as the cross-beam combination for the RMSI PDCCHs or as a cross-SSB burst combination for the RMSI PDCCHs based on at least one of the SSB RSRP threshold or a determination by the UE 602.

In aspects, where the set of configuration indications 606 comprises at least one of RMSI or OSI, the set of PDCCHs 608 may be associated with a multicast or a broadcast over a set of beams for the cross-beam combination. In such aspects, the set of PDCCHs 608 may be the cross-beam combination for the set of PDCCHs 608 associated with a multicast over a subset of the set of beams.

The UE 602 may be configured to combine (at 610) the set of PDCCHs 608 for a cross-beam combination or a cross-SSB burst combination based at least on the set of configuration indications 606. As noted herein, the UE 602 may be configured to combine (at 610) the set of PDCCHs 608 for a cross-beam combination or a cross-SSB burst combination based on at least one of the SSB RSRP threshold or a determination by the UE 602.

FIG. 14 is a diagram 1400 illustrating an example of a hardware implementation for an apparatus 1404. The apparatus 1404 may be a UE, a component of a UE, or may implement UE functionality. In some aspects, the apparatus 1404 may include at least one cellular baseband processor 1424 (also referred to as a modem) coupled to one or more transceivers 1422 (e.g., cellular RF transceiver). The cellular baseband processor(s) 1424 may include at least one on-chip memory 1424′. In some aspects, the apparatus 1404 may further include one or more subscriber identity modules (SIM) cards 1420 and at least one application processor 1406 coupled to a secure digital (SD) card 1408 and a screen 1410. The application processor(s) 1406 may include on-chip memory 1406′. In some aspects, the apparatus 1404 may further include a Bluetooth module 1412, a WLAN module 1414, an SPS module 1416 (e.g., GNSS module), one or more sensor modules 1418 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1426, a power supply 1430, and/or a camera 1432. The Bluetooth module 1412, the WLAN module 1414, and the SPS module 1416 may include an on-chip transceiver (TRX) (or in some cases, just a receiver (RX)). The Bluetooth module 1412, the WLAN module 1414, and the SPS module 1416 may include their own dedicated antennas and/or utilize the antennas 1480 for communication. The cellular baseband processor(s) 1424 communicates through the transceiver(s) 1422 via one or more antennas 1480 with the UE 104 and/or with an RU associated with a network entity 1402. The cellular baseband processor(s) 1424 and the application processor(s) 1406 may each include a computer-readable medium/memory 1424′, 1406′, respectively. The additional memory modules 1426 may also be considered a computer-readable medium/memory. Each computer-readable medium/memory 1424′, 1406′, 1426 may be non-transitory. The cellular baseband processor(s) 1424 and the application processor(s) 1406 are each responsible for general processing, including the execution of software stored on the computer-readable medium/memory. The software, when executed by the cellular baseband processor(s) 1424/application processor(s) 1406, causes the cellular baseband processor(s) 1424/application processor(s) 1406 to perform the various functions described supra. The cellular baseband processor(s) 1424 and the application processor(s) 1406 are configured to perform the various functions described supra based at least in part of the information stored in the memory. That is, the cellular baseband processor(s) 1424 and the application processor(s) 1406 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1424/application processor(s) 1406 when executing software. The cellular baseband processor(s) 1424/application processor(s) 1406 may be a component of the UE 350 and may include the at least one memory 360 and/or at least one of the TX processor 368, the RX processor 356, and the controller/processor 359. In one configuration, the apparatus 1404 may be at least one processor chip (modem and/or application) and include just the cellular baseband processor(s) 1424 and/or the application processor(s) 1406, and in another configuration, the apparatus 1404 may be the entire UE (e.g., see UE 350 of FIG. 3) and include the additional modules of the apparatus 1404.

As discussed supra, the component 198 may be configured to receive, from a network node, a set of configuration indications associated with a cross-beam combination for PDCCHs. The component 198 may be configured to receive, from the network node and in accordance with the set of configuration indications, the PDCCHs. The component 198 may be further configured to perform any of the aspects described in connection with the flowcharts in any of FIGS. 12, 13, and/or any of the aspects performed by a UE for any of FIGS. 4-11. The component 198 may be within the cellular baseband processor(s) 1424, the application processor(s) 1406, or both the cellular baseband processor(s) 1424 and the application processor(s) 1406. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1404 may include a variety of components configured for various functions. In one configuration, the apparatus 1404, and in particular the cellular baseband processor(s) 1424 and/or the application processor(s) 1406, may include means for receiving, from a network node, a set of configuration indications associated with a cross-beam combination for PDCCHs. In one configuration, the apparatus 1404, and in particular the cellular baseband processor(s) 1424 and/or the application processor(s) 1406, may include means for receiving, from the network node and in accordance with the set of configuration indications, the PDCCHs. The means may be the component 198 of the apparatus 1404 configured to perform the functions recited by the means. As described supra, the apparatus 1404 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 15 is a diagram 1500 illustrating an example of a hardware implementation for a network entity 1502. The network entity 1502 may be a BS, a component of a BS, or may implement BS functionality. The network entity 1502 may include at least one of a CU 1510, a DU 1530, or an RU 1540. For example, depending on the layer functionality handled by the component 199, the network entity 1502 may include the CU 1510; both the CU 1510 and the DU 1530; each of the CU 1510, the DU 1530, and the RU 1540; the DU 1530; both the DU 1530 and the RU 1540; or the RU 1540. The CU 1510 may include at least one CU processor 1512. The CU processor(s) 1512 may include on-chip memory 1512′. In some aspects, the CU 1510 may further include additional memory modules 1514 and a communications interface 1518. The CU 1510 communicates with the DU 1530 through a midhaul link, such as an F1 interface. The DU 1530 may include at least one DU processor 1532. The DU processor(s) 1532 may include on-chip memory 1532′. In some aspects, the DU 1530 may further include additional memory modules 1534 and a communications interface 1538. The DU 1530 communicates with the RU 1540 through a fronthaul link. The RU 1540 may include at least one RU processor 1542. The RU processor(s) 1542 may include on-chip memory 1542′. In some aspects, the RU 1540 may further include additional memory modules 1544, one or more transceivers 1546, antennas 1580, and a communications interface 1548. The RU 1540 communicates with the UE 104. The on-chip memory 1512′, 1532′, 1542′ and the additional memory modules 1514, 1534, 1544 may each be considered a computer-readable medium/memory. Each computer-readable medium/memory may be non-transitory. Each of the processors 1512, 1532, 1542 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to provide, for a UE, a set of configuration indications associated with a cross-beam combination for PDCCHs. The component 199 may be configured to provide, for the UE and in accordance with the set of configuration indications, the PDCCHs. The component 199 may be further configured to perform any of the aspects described in connection with the flowcharts in any of FIGS. 12, 13, and/or any of the aspects performed by a network node/network entity for any of FIGS. 4-11. The component 199 may be within one or more processors of one or more of the CU 1510, DU 1530, and the RU 1540. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1502 may include a variety of components configured for various functions. In one configuration, the network entity 1502 may include means for providing, for a UE, a set of configuration indications associated with a cross-beam combination for PDCCHs. In one configuration, the network entity 1502 may include means for providing, for the UE and in accordance with the set of configuration indications, the PDCCHs. The means may be the component 199 of the network entity 1502 configured to perform the functions recited by the means. As described supra, the network entity 1502 may include the TX processor 316, the RX processor 370, and the controller/processor 375. As such, in one configuration, the means may be the TX processor 316, the RX processor 370, and/or the controller/processor 375 configured to perform the functions recited by the means.

A UE may receive various types of system information (SI) in a wireless communication network, e.g., 5G NR or others, through different channels and mechanisms. As examples, a master information block (MIB) via a physical broadcast channel (PBCH) may be periodically broadcast, a type 1 system information block (SIB1), also remaining minimum system information (RMSI) may be provided via a physical downlink shared channel (PDSCH) that is scheduled by a physical downlink control channel (PDCCH) associated with a Type0-CSS (common search space) as a period broadcast, and types 2, 3, 4, etc., SIBs, also other system information (OSI) may be provided via PDSCH scheduled by a PDCCH associated with a Type0A-CSS as on-demand deliver for UE requests. However, in practice, the RMSI PDCCH that schedules the RMSI PDSCH is typically the coverage bottleneck, e.g., in frequency range designation FR2, due to the coarse beam direction stemming from the broadcast nature of the signaling. In addition, the RMSI PDSCH may also become the coverage bottleneck when the RMSI payload is large. Further, issues also exist in repeating the RMSI PDxCH to enhance the coverage as broadcast PDxCH repetition is not favorable due to the overhead involved (e.g., broadcast signaling and repetition lead to larger overhead), and moreover, there are cases where the RMSI PDxCH repetition is not possible, e.g., in synchronization signal block (SSB) multiplexing patterns 2 and 3 that frequency division multiplexes (FDMs) the RMSI PDCCH/PDSCH (also “PDxCH”) with the SSB in FR2. That is, there may be no room for the RMSI PDxCH repetition for the SSB multiplexing patterns 2 and 3. Some current solutions combine RMSI PDxCHs across SSB bursts (e.g., across time) to increase coverage, yet such approaches incur latency of at least 20 ms for each RMSI PDxCH combination.

Aspects herein for cross-beam RMSI PDxCH combining improve coverage and reduce bottlenecks for RMSI PDxCHs. Aspects increase coverage and decrease bottlenecks for RMSI PDxCHs by indicating to a UE that contents of RMSI PDCCHs are identical across SSB within an SSB burst. Aspects also provide for cross-beam combinations even when PDCCH contents are identical by utilizing RV cycling configurations applicable to spatial- and time-domains and that differ from PDCCH RVs. Aspects also enable UEs to combine broadcast/multicast PDCCHs across beams within a monitoring occasion by providing indications of combinable candidate patterns for beams to a UE.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a user equipment (UE), comprising: receiving, from a network node, a set of configuration indications associated with a cross-beam combination for physical downlink control channels (PDCCHs); and receiving, from the network node and in accordance with the set of configuration indications, the PDCCHs.
Aspect 2 is the method of aspect 1, wherein the PDCCHs comprise remaining minimum system information (RMSI), wherein the RMSI is associated with the cross-beam combination for RMSI PDCCHs, wherein a configuration indication of the set of configuration indications is indicative of whether contents of the RMSI PDCCHs are identical across synchronization signal blocks (SSBs) within an SSB burst.
Aspect 3 is the method of aspect 2, wherein the configuration indication is configured for a first value associated with the contents of the RMSI PDCCHs being identical across the SSBs within the SSB burst or a second value associated with the contents of the RMSI PDCCHs being non-identical across the SSBs within the SSB burst.
Aspect 4 is the method of aspect 3, wherein the configuration indication includes a 1-bit field indicator comprised in a master information block (MIB).
Aspect 5 is the method of any of aspects 1 to 4, wherein the PDCCHs comprise remaining minimum system information (RMSI), wherein the RMSI is associated with the cross-beam combination for RMSI PDCCHs, wherein a configuration indication of the set of configuration indications is indicative of contents of the RMSI PDCCHs being identical across synchronization signal blocks (SSBs) for at least one SSB burst of a set of SSB bursts.
Aspect 6 is the method of aspect 5, wherein the configuration indication is configured for a first value associated with each even numbered SSB as the at least one SSB burst, a second value associated with each odd numbered SSB as the at least one SSB burst, a third value associated with a first SSB burst as the at least one SSB burst, or a fourth value associated with no SSB bursts.
Aspect 7 is the method of aspect 6, wherein the configuration indication includes a 2-bit field indicator comprised in a master information block (MIB).
Aspect 8 is the method of any of aspects 1 to 7, wherein the PDCCHs comprise remaining minimum system information (RMSI), wherein a configuration indication of the set of configuration indications is indicative of a redundancy version (RV) cycling configuration associated with RMSI physical downlink shared channels (PDSCHs), wherein the RV cycling configuration is different than an RV indication included in RMSI PDCCHs associated with a scheduling of the RMSI PDSCHs.
Aspect 9 is the method of aspect 8, wherein the RV cycling configuration is associated with (i) the cross-beam combination for the RMSI over the RMSI PDSCHs of a synchronization signal block (SSB) burst and with (ii) a cross-SSB burst combination for the RMSI over a corresponding RMSI PDSCH across a set of SSB bursts.
Aspect 10 is the method of aspect 8, wherein the RV cycling configuration is indicative of different RVs for each synchronization signal block (SSB) of an SSB burst and for each SSB burst of a set of SSB bursts.
Aspect 11 is the method of aspect 10, wherein the RV cycling configuration includes a rotation of the different RVs between each SSB of the SSB burst and between each SSB burst of the set of SSB bursts, wherein the rotation of the different RVs is in accordance with an RV cycling pattern, wherein the RV cycling pattern is based on at least one of a number of RMSI periods, a system frame number (SFN), or a configured period of time.
Aspect 12 is the method of aspect 11, wherein the set of configuration indications comprises a master information block (MIB) that is indicative of a SSB reference signal received power (RSRP) threshold configured at the UE; wherein receiving, from the network node and in accordance with the set of configuration indications, the PDCCHs includes: receiving the PDCCHs as the cross-beam combination for the RMSI PDCCHs or as a cross-SSB burst combination for the RMSI PDCCHs based on at least one of the SSB RSRP threshold or a determination by the UE.
Aspect 13 is the method of aspect 1, wherein the set of configuration indications comprises at least one of remaining minimum system information (RMSI), other system information (OSI), or radio resource control (RRC) signaling; wherein the PDCCHs are associated with a multicast or a broadcast over a set of beams for the cross-beam combination; wherein the set of configuration indications is indicative of at least one of a PDCCH candidate identifier, a search space identifier, a radio network temporary identifier (RNTI), or a set of monitoring occasions associated with combinable PDCCH candidates for the cross-beam combination.
Aspect 14 is the method of aspect 13, wherein the PDCCHs are the cross-beam combination for the PDCCHs associated with the multicast over a subset of the set of beams; wherein the set of configuration indications is indicative of the set of monitoring occasions and a presence of each multicast PDCCH and associated beam at ones of the set of monitoring occasions.
Aspect 15 is a method of wireless communication at a network node, comprising: providing, for a user equipment (UE), a set of configuration indications associated with a cross-beam combination for physical downlink control channels (PDCCHs); and providing, for the UE and in accordance with the set of configuration indications, the PDCCHs.
Aspect 16 is the method of aspect 15, wherein the PDCCHs comprise remaining minimum system information (RMSI), wherein the RMSI is associated with the cross-beam combination for RMSI PDCCHs, wherein a configuration indication of the set of configuration indications is indicative of whether contents of the RMSI PDCCHs are identical across synchronization signal blocks (SSBs) within an SSB burst.
Aspect 17 is the method of aspect 16, wherein the configuration indication is configured for a first value associated with the contents of the RMSI PDCCHs being identical across the SSBs within the SSB burst or a second value associated with the contents of the RMSI PDCCHs being non-identical across the SSBs within the SSB burst.
Aspect 18 is the method of aspect 17, wherein the configuration indication includes a 1-bit field indicator comprised in a master information block (MIB).
Aspect 19 is the method of any of aspects 15 to 18, wherein the PDCCHs comprise remaining minimum system information (RMSI), wherein the RMSI is associated with the cross-beam combination for RMSI PDCCHs, wherein a configuration indication of the set of configuration indications is indicative of contents of the RMSI PDCCHs being identical across synchronization signal blocks (SSBs) for at least one SSB burst of a set of SSB bursts.
Aspect 20 is the method of aspect 19, wherein the configuration indication is configured for a first value associated with each even numbered SSB as the at least one SSB burst, a second value associated with each odd numbered SSB as the at least one SSB burst, a third value associated with a first SSB burst as the at least one SSB burst, or a fourth value associated with no SSB bursts.
Aspect 21 is the method of aspect 20, wherein the configuration indication includes a 2-bit field indicator comprised in a master information block (MIB).
Aspect 22 is the method of any of aspects 15 to 21, wherein the PDCCHs comprise remaining minimum system information (RMSI), wherein a configuration indication of the set of configuration indications is indicative of a redundancy version (RV) cycling configuration associated with RMSI physical downlink shared channels (PDSCHs), wherein the RV cycling configuration is different than an RV indication included in RMSI PDCCHs associated with a scheduling of the RMSI PDSCHs.
Aspect 23 is the method of aspect 22, wherein the RV cycling configuration is associated with (i) the cross-beam combination for the RMSI over the RMSI PDSCHs of a synchronization signal block (SSB) burst and with (ii) a cross-SSB burst combination for the RMSI over a corresponding RMSI PDSCH across a set of SSB bursts.
Aspect 24 is the method of aspect 22, wherein the RV cycling configuration is indicative of different RVs for each synchronization signal block (SSB) of an SSB burst and for each SSB burst of a set of SSB bursts.
Aspect 25 is the method of aspect 24, wherein the RV cycling configuration includes a rotation of the different RVs between each SSB of the SSB burst and between each SSB burst of the set of SSB bursts, wherein the rotation of the different RVs is in accordance with an RV cycling pattern, wherein the RV cycling pattern is based on at least one of a number of RMSI periods, a system frame number (SFN), or a configured period of time.
Aspect 26 is the method of aspect 25, wherein the set of configuration indications comprises a master information block (MIB) that is indicative of a SSB reference signal received power (RSRP) threshold configured at the UE; wherein providing, for the UE and in accordance with the set of configuration indications, the PDCCHs includes: providing the PDCCHs as the cross-beam combination for the RMSI PDCCHs or as a cross-SSB burst combination for the RMSI PDCCHs.
Aspect 27 is the method of aspect 15, wherein the set of configuration indications comprises at least one of remaining minimum system information (RMSI), other system information (OSI), or radio resource control (RRC) signaling; wherein the PDCCHs are associated with a multicast or a broadcast over a set of beams for the cross-beam combination; wherein the set of configuration indications is indicative of at least one of a PDCCH candidate identifier, a search space identifier, a radio network temporary identifier (RNTI), or a set of monitoring occasions associated with combinable PDCCH candidates for the cross-beam combination.
Aspect 28 is the method of aspect 27, wherein the PDCCHs are the cross-beam combination for the PDCCHs associated with the multicast over a subset of the set of beams; wherein the set of configuration indications is indicative of the set of monitoring occasions and a presence of each multicast PDCCH and associated beam at ones of the set of monitoring occasions.
Aspect 29 is an apparatus for wireless communication at a user equipment (UE), comprising: at least one memory; and at least one processor coupled to the at least one memory, the at least one processor, individually or in any combination, is configured to perform the method of any of aspects 1 to 14.
Aspect 30 is an apparatus for wireless communication at a user equipment (UE), comprising means for performing each step in the method of any of aspects 1 to 14.
Aspect 31 is the apparatus of any of aspects 29 to 30, further comprising a transceiver configured to receive or to transmit in association with the method of any of aspects 1 to 14.
Aspect 32 is a computer-readable medium (e.g., a non-transitory computer-readable medium) storing computer executable code at a user equipment (UE), the code when executed by at least one processor causes the at least one processor to perform the method of any of aspects 1 to 14.
Aspect 33 is an apparatus for wireless communication at a network node, comprising: at least one memory; and at least one processor coupled to the at least one memory, the at least one processor, individually or in any combination, is configured to perform the method of any of aspects 15 to 28.
Aspect 34 is an apparatus for wireless communication at a network node, comprising means for performing each step in the method of any of aspects 15 to 28.
Aspect 35 is the apparatus of any of aspects 33 to 34, further comprising a transceiver configured to receive or to transmit in association with the method of any of aspects 15 to 28.
Aspect 36 is a computer-readable medium (e.g., a non-transitory computer-readable medium) storing computer executable code at a network node, the code when executed by at least one processor causes the at least one processor to perform the method of any of aspects 15 to 28.

What is claimed is:

1. An apparatus of wireless communication at a user equipment (UE), comprising:
at least one memory; and
at least one processor coupled to the at least one memory and, based at least in part on information stored in the at least one memory, the at least one processor, individually or in any combination, is configured to:
receive, from a network node, a set of configuration indications associated with a cross-beam combination for physical downlink control channels (PDCCHs); and
receive, from the network node and in accordance with the set of configuration indications, the PDCCHs.

2. The apparatus of claim 1, wherein the PDCCHs comprise remaining minimum system information (RMSI), wherein the RMSI is associated with the cross-beam combination for RMSI PDCCHs, wherein a configuration indication of the set of configuration indications is indicative of whether contents of the RMSI PDCCHs are identical across synchronization signal blocks (SSBs) within an SSB burst.

3. The apparatus of claim 2, wherein the configuration indication is configured for a first value associated with the contents of the RMSI PDCCHs being identical across the SSBs within the SSB burst or a second value associated with the contents of the RMSI PDCCHs being non-identical across the SSBs within the SSB burst.

4. The apparatus of claim 3, wherein the configuration indication includes a 1-bit field indicator comprised in a master information block (MIB).

5. The apparatus of claim 1, wherein the PDCCHs comprise remaining minimum system information (RMSI), wherein the RMSI is associated with the cross-beam combination for RMSI PDCCHs, wherein a configuration indication of the set of configuration indications is indicative of contents of the RMSI PDCCHs being identical across synchronization signal blocks (SSBs) for at least one SSB burst of a set of SSB bursts.

6. The apparatus of claim 5, wherein the configuration indication is configured for a first value associated with each even numbered SSB as the at least one SSB burst, a second value associated with each odd numbered SSB as the at least one SSB burst, a third value associated with a first SSB burst as the at least one SSB burst, or a fourth value associated with no SSB bursts.

7. The apparatus of claim 6, wherein the configuration indication includes a 2-bit field indicator comprised in a master information block (MIB).

8. The apparatus of claim 1, wherein the PDCCHs comprise remaining minimum system information (RMSI), wherein a configuration indication of the set of configuration indications is indicative of a redundancy version (RV) cycling configuration associated with RMSI physical downlink shared channels (PDSCHs), wherein the RV cycling configuration is different than an RV indication included in RMSI PDCCHs associated with a scheduling of the RMSI PDSCHs.

9. The apparatus of claim 8, wherein the RV cycling configuration is associated with (i) the cross-beam combination for the RMSI over the RMSI PDSCHs of a synchronization signal block (SSB) burst and with (ii) a cross-SSB burst combination for the RMSI over a corresponding RMSI PDSCH across a set of SSB bursts.

10. The apparatus of claim 8, wherein the RV cycling configuration is indicative of different RVs for each synchronization signal block (SSB) of an SSB burst and for each SSB burst of a set of SSB bursts.

11. The apparatus of claim 10, wherein the RV cycling configuration includes a rotation of the different RVs between each SSB of the SSB burst and between each SSB burst of the set of SSB bursts, wherein the rotation of the different RVs is in accordance with an RV cycling pattern, wherein the RV cycling pattern is based on at least one of a number of RMSI periods, a system frame number (SFN), or a configured period of time.

12. The apparatus of claim 11, further comprising at least one transceiver coupled to the at least one processor, wherein the set of configuration indications comprises a master information block (MIB) that is indicative of a SSB reference signal received power (RSRP) threshold configured at the UE;
wherein to receive, from the network node and in accordance with the set of configuration indications, the PDCCHs, the at least one processor is configured to:
receive, via the at least one transceiver, the PDCCHs as the cross-beam combination for the RMSI PDCCHs or as a cross-SSB burst combination for the RMSI PDCCHs based on at least one of the SSB RSRP threshold or a determination by the UE.

13. The apparatus of claim 1, wherein the set of configuration indications comprises at least one of remaining minimum system (RMSI), other system information (OSI), or radio resource control (RRC) signaling;
wherein the PDCCHs are associated with a multicast or a broadcast over a set of beams for the cross-beam combination;
wherein the set of configuration indications is indicative of at least one of a PDCCH candidate identifier, a search space identifier, a radio network temporary identifier (RNTI), or a set of monitoring occasions associated with combinable PDCCH candidates for the cross-beam combination.

14. The apparatus of claim 13, wherein the PDCCHs are the cross-beam combination for the PDCCHs associated with the multicast over a subset of the set of beams;
wherein the set of configuration indications is indicative of the set of monitoring occasions and a presence of each multicast PDCCH and associated beam at ones of the set of monitoring occasions.

15. An apparatus of wireless communication at a network node, comprising:
at least one memory; and
at least one processor coupled to the at least one memory and, based at least in part on information stored in the at least one memory, the at least one processor, individually or in any combination, is configured to:
provide, for a user equipment (UE), a set of configuration indications associated with a cross-beam combination for physical downlink control channels (PDCCHs); and
provide, for the UE and in accordance with the set of configuration indications, the PDCCHs.

16. The apparatus of claim 15, wherein the PDCCHs comprise remaining minimum system information (RMSI), wherein the RMSI is associated with the cross-beam combination for RMSI PDCCHs, wherein a configuration indication of the set of configuration indications is indicative of whether contents of the RMSI PDCCHs are identical across synchronization signal blocks (SSBs) within an SSB burst.

17. The apparatus of claim 16, wherein the configuration indication is configured for a first value associated with the contents of the RMSI PDCCHs being identical across the SSBs within the SSB burst or a second value associated with the contents of the RMSI PDCCHs being non-identical across the SSBs within the SSB burst.

18. The apparatus of claim 17, wherein the configuration indication includes a 1-bit field indicator comprised in a master information block (MIB).

19. The apparatus of claim 15, wherein the PDCCHs comprise remaining minimum system information (RMSI), wherein the RMSI is associated with the cross-beam combination for RMSI PDCCHs, wherein a configuration indication of the set of configuration indications is indicative of contents of the RMSI PDCCHs being identical across synchronization signal blocks (SSBs) for at least one SSB burst of a set of SSB bursts.

20. The apparatus of claim 19, wherein the configuration indication is configured for a first value associated with each even numbered SSB as the at least one SSB burst, a second value associated with each odd numbered SSB as the at least one SSB burst, a third value associated with a first SSB burst as the at least one SSB burst, or a fourth value associated with no SSB bursts.

21. The apparatus of claim 20, wherein the configuration indication includes a 2-bit field indicator comprised in a master information block (MIB).

22. The apparatus of claim 15, wherein the PDCCHs comprise remaining minimum system information (RMSI), wherein a configuration indication of the set of configuration indications is indicative of a redundancy version (RV) cycling configuration associated with RMSI physical downlink shared channels (PDSCHs), wherein the RV cycling configuration is different than an RV indication included in RMSI PDCCHs associated with a scheduling of the RMSI PDSCHs.

23. The apparatus of claim 22, wherein the RV cycling configuration is associated with (i) the cross-beam combination for the RMSI over the RMSI PDSCHs of a synchronization signal block (SSB) burst and with (ii) a cross-SSB burst combination for the RMSI over a corresponding RMSI PDSCH across a set of SSB bursts.

24. The apparatus of claim 22, wherein the RV cycling configuration is indicative of different RVs for each synchronization signal block (SSB) of an SSB burst and for each SSB burst of a set of SSB bursts.

25. The apparatus of claim 24, wherein the RV cycling configuration includes a rotation of the different RVs between each SSB of the SSB burst and between each SSB burst of the set of SSB bursts, wherein the rotation of the different RVs is in accordance with an RV cycling pattern, wherein the RV cycling pattern is based on at least one of a number of RMSI periods, a system frame number (SFN), or a configured period of time.

26. The apparatus of claim 25, further comprising at least one transceiver coupled to the at least one processor, wherein the set of configuration indications comprises a master information block (MIB) that is indicative of a SSB reference signal received power (RSRP) threshold configured at the UE;
wherein to provide, for the UE and in accordance with the set of configuration indications, the PDCCHs, the at least one processor is configured to:
provide, via the at least one transceiver, the PDCCHs as the cross-beam combination for the RMSI PDCCHs or as a cross-SSB burst combination for the RMSI PDCCHs.

27. The apparatus of claim 15, wherein the set of configuration indications comprises at least one of remaining minimum system information (RMSI), other system information (OSI), or radio resource control (RRC) signaling;
wherein the PDCCHs are associated with a multicast or a broadcast over a set of beams for the cross-beam combination;
wherein the set of configuration indications is indicative of at least one of a PDCCH candidate identifier, a search space identifier, a radio network temporary identifier (RNTI), or a set of monitoring occasions associated with combinable PDCCH candidates for the cross-beam combination.

28. The apparatus of claim 27, wherein the PDCCHs are the cross-beam combination for the PDCCHs associated with the multicast over a subset of the set of beams;
wherein the set of configuration indications is indicative of the set of monitoring occasions and a presence of each multicast PDCCH and associated beam at ones of the set of monitoring occasions.

29. A method of wireless communication at a user equipment (UE), comprising:
receiving, from a network node, a set of configuration indications associated with a cross-beam combination for physical downlink control channels (PDCCHs); and
receiving, from the network node and in accordance with the set of configuration indications, the PDCCHs.

30. A method of wireless communication at a network node, comprising:
providing, for a user equipment (UE), a set of configuration indications associated with a cross-beam combination for physical downlink control channels (PDCCHs); and
providing, for the UE and in accordance with the set of configuration indications, the PDCCHs.
